(19) United States
(12) Patent Application Publication
(10) Pub. No.: US 2024/0163408 A1
(43) Pub. Date: May 16, 2024

(54) PROJECTION SYSTEM AND METHOD OF DRIVING A PROJECTION SYSTEM WITH FIELD MAPPING

(71) Applicants: Dolby Laboratories Licensing Corporation, San Francisco, CA (US); Dolby International AB, Dublin (IE)

(72) Inventors: Angelo Miguel PIRES ARRIFANO, Villeneuve-Loubet (FR); Clement Luc Carol LE BARBENCHON, Los Angeles, CA (US); Juan Pablo PERTIERRA, Fishers, IN (US)

(73) Assignees: Dolby Laboratories Licensing Corporation, San Francisco, CA (US); Dolby International AB, Dublin (IE)

(21) Appl. No.: 18/549,667

(22) PCT Filed: Mar. 24, 2022
(86) PCT No.: PCT/US2022/021823

§ 371 Date: Sep. 8, 2023

Related U.S. Application Data
(60) Provisional application No. 63/165,846, filed on Mar. 25, 2021.

(30) Foreign Application Priority Data
Mar. 25, 2021 (EP) 21164809.2

(51) Int. Cl. H04N 9/31

(52) U.S. Cl. CPC H04N 9/3194; H04N 9/3138; H04N 9/3155; H04N 9/3188

(57) ABSTRACT

A projection system includes a light source configured to emit a light in response to an image data, a phase light modulator configured to receive the light from the light source and to apply a spatially-varying phase modulation on the light, thereby generating a projection light and steering the light on a reconstruction field, wherein the reconstruction field is a complex plane on which a reconstruction image is formed, and a controller configured to control the light source, control the phase light modulator, initialize (401) the reconstruction field to an initial value, and iteratively for each of a plurality of subframes within a frame of the image data: set (402) the reconstruction field to the initial value for the first iteration or set (402) the reconstruction field to a subsequent-iteration reconstruction field value for any subsequent-iteration, map (403) the reconstruction field to a modulation field, wherein the modulation field is a complex plane of the phase light modulator which modulates a phase of the light, set (404) an amplitude of the modulation field to a predetermined value, and map (405) the modulation field with the amplitude set to the predetermined value, to a subsequent-iteration reconstruction field, wherein the controller is further configured to provide (408) a phase control signal based on the modulation field mapped with the last iteration to the phase light modulator.

### CROSS REFERENCE TO RELATED APPLICATIONS

This application claims priority to U.S. Provisional Application No. 63/165,846, filed Mar. 25, 2021, and EP Application No. 21164809.2, filed Mar. 25, 2021, all of which are incorporated herein by reference in their entirety.

### BACKGROUND

### 1. Field of the Disclosure

This application relates generally to projection systems and methods of driving a projection system.

### 2. Description of Related Art

Digital projection systems typically utilize a light source and an optical system to project an image onto a surface or screen. The optical system includes components such as mirrors, lenses, waveguides, optical fibers, beam splitters, diffusers, spatial light modulators (SLMs), and the like. Some projection systems are based on SLMs that implement spatial amplitude modulation. In such a system, the light source provides a light field that embodies the brightest level that can be reproduced on the image, and light is attenuated (e.g., discarded) in order to create the desired scene levels. In such a configuration, light that is not projected to form any part of the image is attenuated or discarded. Alternatively, a projection system may be configured such that light is steered instead of attenuated. Such systems may operate by generating a complex phase signal and providing the signal to a modulator, such as a phase light modulator (PLM).

### BRIEF SUMMARY OF THE DISCLOSURE

Various aspects of the present disclosure relate to circuits, systems, and methods for projection display using phase light modulation to generate a precise and accurate reproduction of a target image.

In one exemplary aspect of the present disclosure, there is provided a projection system comprising: a light source configured to emit a light in response to an image data; a phase light modulator configured to receive the light from the light source and to apply a spatially-varying phase modulation on the light, thereby to steer the light and generate a projection light; and a controller configured to control the light source, control the phase light modulator, and iteratively for each of a plurality of subframes within a frame of the image data: determine a reconstruction field, map the reconstruction field to a modulation field, scale an amplitude of the modulation field, map the modulation field to a subsequent-iteration reconstruction field, and provide a phase control signal based on the modulation field to the phase light modulator.

In another exemplary aspect of the present disclosure, there is provided a method of driving a projection system comprising emitting a light by a light source, in response to an image data; receiving the light by a phase light modulator; applying a spatially-varying phase modulation on the light by the phase light modulator, thereby to steer the light and generate a projection light; and iteratively, with a controller configured to control the light source and the phase light modulator, for each of a plurality of subframes within a frame of the image data: determining a reconstruction field, mapping the reconstruction field to a modulation field, scaling an amplitude of the modulation field, mapping the modulation field to a subsequent-iteration reconstruction field, and providing a phase control signal based on the modulation field to the phase light modulator.

### DESCRIPTION OF THE DRAWINGS

These and other more detailed and specific features of various embodiments are more fully disclosed in the following description, reference being had to the accompanying drawings, in which:

FIG. 1 illustrates a block diagram of an exemplary projection system according to various aspects of the present disclosure;

FIG. 2 illustrates an exemplary phase modulator according to various aspects of the present disclosure;

FIG. 3 illustrates another exemplary phase modulator according to various aspects of the present disclosure;

FIG. 4 illustrates an exemplary wave propagation loop according to various aspects of the present disclosure;

FIG. 5 illustrates an exemplary wave propagation loop with regularization according to various aspects of the present disclosure;

FIGS. 6A-6E respectively illustrate exemplary image frames according to various aspects of the present disclosure;

FIGS. 7A-7E respectively illustrate exemplary image frames according to various aspects of the present disclosure;

FIG. 8 illustrates an exemplary intensity convergence graph according to various aspects of the present disclosure;

FIG. 9 illustrates another exemplary intensity convergence graph according to various aspects of the present disclosure;

FIG. 10 illustrates an exemplary wave propagation loop with a beam-steering dump according to various aspects of the present disclosure;

FIGS. 11A-11C respectively illustrate exemplary image frames according to various aspects of the present disclosure;

FIGS. 12A-12C respectively illustrate exemplary image frames according to various aspects of the present disclosure;

FIGS. 13A-13C respectively illustrate exemplary image frames according to various aspects of the present disclosure;

FIG. 14 illustrates an exemplary outer-loop feedback process according to various aspects of the present disclosure;

FIGS. 15A-15D respectively illustrate exemplary image frames according to various aspects of the present disclosure;

FIGS. 16A-16C respectively illustrate exemplary image frames according to various aspects of the present disclosure;

FIGS. 17A-17B respectively illustrate exemplary cross-section graphs according to various aspects of the present disclosure;

FIG. 18 illustrates an exemplary noise-ratio convergence graph according to various aspects of the present disclosure;

FIGS. 19A-19B respectively illustrate exemplary image frames according to various aspects of the present disclosure;

FIGS. 20A-20C respectively illustrate exemplary image frames according to various aspects of the present disclosure;

FIG. 21 illustrates an exemplary phase input vs. output graph according to various aspects of the present disclosure;

FIGS. 22A-22C respectively illustrate exemplary image frames according to various aspects of the present disclosure;

FIGS. 23A-23B respectively illustrate exemplary phase distribution graphs according to various aspects of the present disclosure; and

FIGS. 24A-24C respectively illustrate exemplary image frames according to various aspects of the present disclosure.

### DETAILED DESCRIPTION

This disclosure and aspects thereof can be embodied in various forms, including hardware or circuits controlled by computer-implemented methods, computer program products, computer systems and networks, user interfaces, and application programming interfaces; as well as hardware-implemented methods, signal processing circuits, memory arrays, application specific integrated circuits (ASICs), field programmable gate arrays (FPGAs), and the like. The foregoing summary is intended solely to give a general idea of various aspects of the present disclosure, and does not limit the scope of the disclosure in any way.

In the following description, numerous details are set forth, such as circuit configurations, timings, operations, and the like, in order to provide an understanding of one or more aspects of the present disclosure. It will be readily apparent to one skilled in the art that these specific details are merely exemplary and not intended to limit the scope of this application.

Moreover, while the present disclosure focuses mainly on examples in which the various circuits are used in digital projection systems, it will be understood that this is merely one example of an implementation. It will further be understood that the disclosed systems and methods can be used in any device in which there is a need to project light; for example, cinema, consumer and other commercial projection systems, heads-up displays, virtual reality displays, and the like.

### Projector Systems

In comparative projection systems based on a PLM, generating the complex phase signal has presented challenges. For example, comparative algorithms may create images that appear similar to a target image, but have an excess or deficit of light at unpredictable locations, or may have other artifacts which ruin the quality of the reproduction. If the comparative projection systems are dual-modulation systems, light deficits, unless addressed by the algorithm, may only be overcome by increasing the diffuse illumination. This may be prohibitive due to cost and/or efficiency considerations. The present disclosure provides for phase modulation image projection systems involving single (i.e., phase-only) or multiple stages of modulation, and implement features such as algorithms which can create accurate reconstructions of the target image and, in the case of multiple modulation stages, create a reproduction that is appropriate for compensation by the downstream modulator(s).

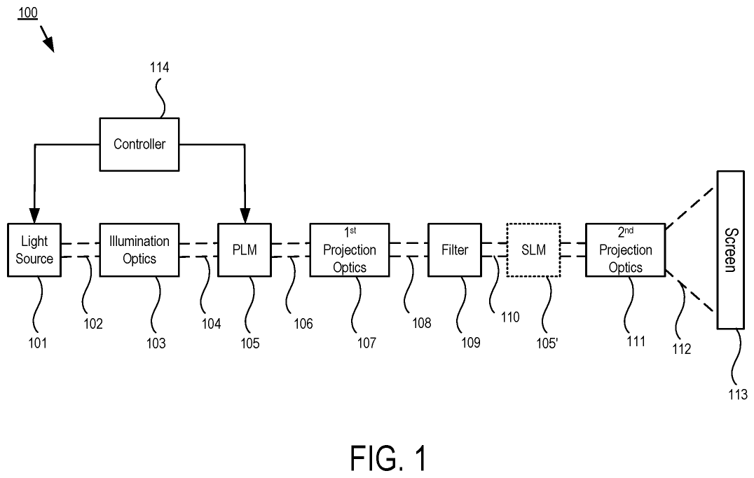

FIG. 1 illustrates a block diagram of an exemplary projection system 100 according to various aspects of the present disclosure. Specifically, FIG. 1 illustrates a projection system 100 which includes a light source 101 configured to emit a first light 102; illumination optics 103 configured to receive the first light 102 and redirect or otherwise modify it, thereby to generate a second light 104; a PLM 105 configured to apply a spatially-varying phase modulation to the second light 104, thereby to steer the second light 104 and generate a third light 106; first projection optics 107 configured to receive the third light 106 and redirect or otherwise modify it, thereby to generate a fourth light 108; a filter 109 configured to filter the fourth light 108, thereby to generate a fifth light 110; and second projection optics 111 configured to receive the fifth light 110 and project it as a sixth light 112 onto a screen 113.

The projection system 100 further includes a controller 114 configured to control various components of the projection system 100, such as the light source 101 and/or the PLM 105. In some implementations, the controller 114 may additionally or alternatively control other components of the projection system 100, including but not limited to the illumination optics 103, the first projection optics 107, and/or the second projection optics 111. The controller 114 may be one or more processors such as a central processing unit (CPU) of the projection system 100. The illumination optics 103, the first projection optics 107, and the second projection optics 111 may respectively include one or more optical components such as mirrors, lenses, waveguides, optical fibers, beam splitters, diffusers, and the like. Moreover, while FIG. 1 illustrates a single modulator as affirmatively present, the projection system 100 may other modulators in addition to the PLM 105. For example, the first projection optics 107 may include an amplitude-based SLM or other secondary modulator 105′, illustrated in FIG. 1 with a dotted line. When present, SLM 105′ may be located optically upstream from the second projection optics 111 so as to modulate the fifth light 110, and may be controlled by the controller 114. For example, the controller 114 may provide a control signal to the SLM 105′ to control the individual modulation elements of the SLM 105′; this control signal may be calculated at least in part based on the phase configuration. With the exception of the screen 113, the components illustrated in FIG. 1 may be integrated into a housing to provide a projection device. Such a projection device may include additional components such as a memory, input/output ports, communication circuitry, a power supply, and the like.

The light source 101 may be, for example, a laser light source and the like. Generally, the light source 101 is any light emitter which emits, e.g. coherent, light. In some aspects of the present disclosure, the light source 101 may comprise multiple individual light emitters, each corresponding to a different wavelength or wavelength band. The light source 101 emits light in response to an image signal provided by the controller 114. The image signal includes image data corresponding to a plurality of frames to be successively displayed. The image signal may originate from an external source in a streaming or cloud-based manner, may originate from an internal memory of the projection system 100 such as a hard disk, may originate from a removable medium that is operatively connected to the projection system 100, or combinations thereof.

The filter 109 may be provided to mitigate effects caused by internal components of the projection system 100. In some systems, the PLM 105 (which will be described in more detail below) may include a cover glass and cause reflections, device switching may temporarily cause unwanted steering angles, and various components may cause scattering. To counteract this and decrease the floor level of the projection system 100, the filter 109 may be a Fourier (“DC”) filter component configured to block a portion of the fourth light 108. Thus, the filter 109 may increase contrast by reducing the floor level from light near zero angle, which will correspond to such elements as cover-glass reflections, stroke transition states, and the like. This DC block region may be actively used by the algorithm to prevent certain light from reaching the screen. In some aspects of the present disclosure, the filter 109 prevents the undesired light from reaching the screen by steering said light to a light dump located outside the active image area, in response to control from the controller 114.

### Phase Light Modulator

As illustrated in FIG. 1, the controller 114 also controls the PLM 105, which receives light from the light source 101. The PLM 105 imparts a spatially-varying phase modulation to the light, and redirects the modulated light toward the second projection optics 111. The PLM 105 may be a reflective type, in which the PLM 105 reflects incident light with a spatially-varying phase; alternatively, the PLM 105 may be of a transmissive type, in which the PLM 105 imparts a spatially-varying phase to light as it passes through the PLM 105. In some aspects of the present disclosure, the PLM 105 has a liquid-crystal-on-silicon (LCOS) architecture. In other aspects of the present disclosure, the PLM 105 has a micro-electromechanical system (MEMS) architecture such as a digital micromirror device (DMD).

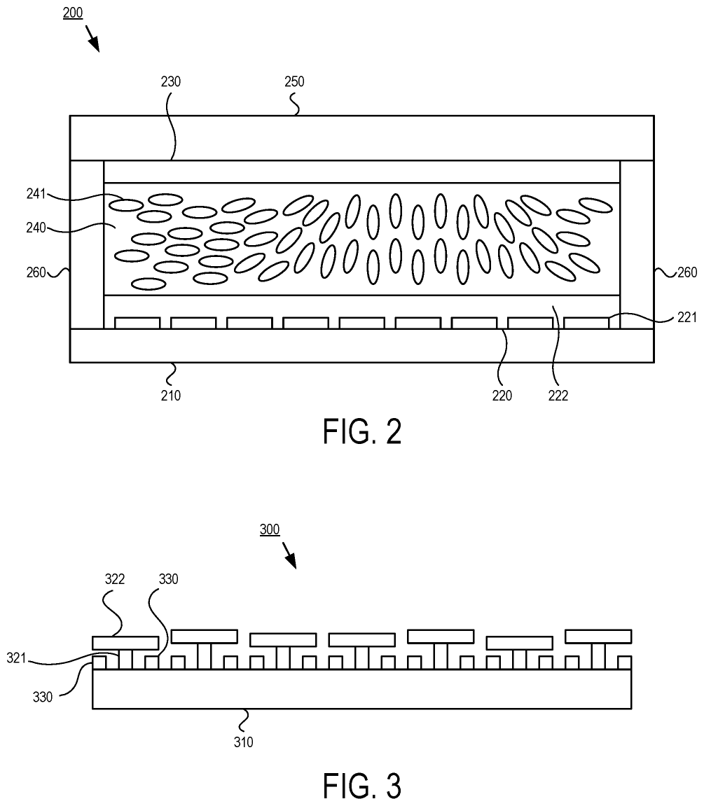

FIG. 2 illustrates one example of the PLM 105, implemented as a reflective LCOS PLM 200 and shown in a partial cross-sectional view. As illustrated in FIG. 2, the PLM 200 includes a silicon backplane 210, a first electrode layer 220, a second electrode layer 230, a liquid crystal layer 240, a cover glass 250, and spacers 260. The silicon backplane 210 includes electronic circuitry associated with the PLM 200, such as complementary metal-oxide semiconductor (CMOS) transistors and the like. The first electrode layer 220 includes an array of reflective elements 221 disposed in a transparent matrix 222. The reflective elements 221 may be formed of any highly optically reflective material, such as aluminum or silver. The transparent matrix 222 may be formed of any highly optically transmissive material, such as a transparent oxide. The second electrode layer 230 may be formed of any optically transparent electrically conductive material, such as a thin film of indium tin oxide (ITO). The second electrode layer 230 may be provided as a common electrode corresponding to a plurality of the reflective elements 221 of the first electrode layer 220. In such a configuration, each of the plurality of the reflective elements 221 will couple to the second electrode layer 230 via a respective electric field, thus dividing the PLM 200 into an array of pixel elements. Thus, individual ones (or subsets) of the plurality of the reflective elements 221 may be addressed via the electronic circuitry disposed in the silicon backplane 210, thereby to modify the state of the corresponding reflective element 221.

The liquid crystal layer 240 is disposed between the first electrode layer 220 and the second electrode layer 230, and includes a plurality of liquid crystals 241. The liquid crystals 241 are particles which exist in a phase intermediate between a solid and a liquid; in other words, the liquid crystals 241 exhibit a degree of directional order, but not positional order. The direction in which the liquid crystals 241 tend to point is referred to as the “director.” The liquid crystal layer 240 modifies incident light entering from the cover glass 250 based on the birefringence Δn of the liquid crystals 241, which may be expressed as the difference between the refractive index in a direction parallel to the director and the refractive index in a direction perpendicular to the director. From this, the maximum optical path difference may be expressed as the birefringence multiplied by the thickness of the liquid crystal layer 240. This thickness is set by the spacer 260, which seals the PLM 200 and ensures a set distance between the cover glass 250 and the silicon backplane 210. The liquid crystals 241 generally orient themselves along electric field lines between the first electrode layer 220 and the second electrode layer 230. As illustrated in FIG. 2, the liquid crystals 241 near the center of the PLM 200 are oriented in this manner, whereas the liquid crystals 241 near the periphery of the PLM 200 are substantially non-oriented in the absence of electric field lines. By addressing individual ones of the plurality of reflective elements 221 via a phase-drive signal, the orientation of the liquid crystals 241 may be determined on a pixel-by-pixel basis.

FIG. 3 illustrates another example of the PLM 105, implemented as a DMD PLM 300 and shown in a partial cross-sectional view. As illustrated in FIG. 3, the PLM 300 includes a backplane 310 and a plurality of controllable reflective elements as pixel elements, each of which includes a yoke 321, a mirror plate 322, and a pair of electrodes 330. While only two electrodes 330 are visible in the cross-sectional view of FIG. 3, each reflective element may in practice include additional electrodes. While not particularly illustrated in FIG. 3, the PLM 300 may further include spacer layers, support layers, hinge components to control the height or orientation of the mirror plate 322, and the like. The backplane 310 includes electronic circuitry associated with the PLM 300, such as CMOS transistors, a memory array, and the like.

The yoke 321 may be formed of or include an electrically conductive material so as to permit a biasing voltage to be applied to the mirror plate 322. The mirror plate 322 may be formed of any highly reflective material, such as aluminum or silver. The electrodes 330 are configured to receive a first voltage and a second voltage, respectively, and may be individually addressable. Depending on the values of a voltage on the electrodes 330 and a voltage (for example, the biasing voltage) on the mirror plate 322, a potential difference exists between the mirror plate 322 and the electrodes 330, which creates an electrostatic force that operates on the mirror plate 322. The yoke 321 is configured to allow vertical movement of the mirror plate 322 in response to the electrostatic force. The equilibrium position of the mirror plate 322, which occurs when the electrostatic force and a spring-like force of the yoke 322 are equal, determines the optical path length of light reflected from the upper surface of the mirror plate 322. Thus, individual ones of the plurality of controllable reflective elements are controlled to provide a number (as illustrated, three) of discrete heights and thus a number of discrete phase configurations or phase states. As illustrated, each of the phase states has a flat profile. In some aspects of the present disclosure, the electrodes 330 may be provided with different voltages from one another so as to impart a tilt to the mirror plate 322. Such tilt may be utilized with a light dump of the type described above.

The PLM 300 may be capable of high switching speeds, such that the PLM 300 switches from one phase state on the order of tens of μs, for example. In order to provide for a full cycle of phase control, the total optical path difference between a state where the mirror plate 322 is at its highest point and a state where the mirror plate 322 is at its lowest point should be approximately equal to the wavelength λ of incident light. Thus, the height range between the highest point and the lowest point should be approximately equal to λ/2.

Regardless of which particular architecture is used for the PLM 105, it is controlled by the controller 114 to take particular phase configurations on a pixel-by-pixel basis. Thus, the PLM 105 utilizes an array of the respective pixel elements, such as a 960×540 array. The number of pixel elements in the array may correspond to the resolution of the PLM 105. Due to the beam-steering that capabilities of the PLM 105, light may be steered to any location on the reconstruction image plane. The reconstruction image plane is not constrained to be the same pixel grid as the PLM 105. The reconstruction image plane may be located anywhere between the PLM 105 and the first projection optics 107. In a dual-modulation configuration, for example, the reconstruction image is imaged onto the secondary modulator 105′ through the first projection optics 107. As the PLM 105 is capable of a fast response time, high-resolution moving images may be generated on the reconstruction image plane. The operation of the PLM 105 may be affected by the data bandwidth of the projection system 100, stroke quantization of the PLM 105, and/or response time of the PLM 105. The maximum resolution may be determined by the point-spread function (PSF) of the light source 101 and on parameters of various optical components in the projection system 100. Because the PLM 105 in accordance with the present disclosure is capable of a fast response time, multiple phase configurations can be presented in succession for a single frame, which are then integrated by the human eye into a high-quality image.

### Phase Configurations and Wave-Propagation Loop

The fast response time of the PLM 105 may be leveraged by a method that uses an iterative back-and-forth wave-propagation loop to estimate the PLM phase configuration to reconstruct a target light field (e.g., a target image). The iterative back-and-forth wave-propagation loop may be based on a loop as describe in, for example, commonly-owned U.S. patent application Ser. No. 16/650,545, the entire contents of which are herein incorporated by reference. In the reference example, a random or quasi-random phase is used as an initialization seed for the iterative wave-propagation loop. By doing so, for the same target image in each subframe, the wave-propagation loop produces a different phase configuration that reconstructs an approximation of the target image. Due at least in part to the fast response time of the PLM 105, presenting these reconstructed image (subframes) in quick succession may lead to a temporally integrated image that may mitigate artifacts (e.g., when the PLM 105 transitions from one phase configuration to the next). Such a method may use a low-pass or band-pass angular filter (e.g., an algorithmic filter) selected for a particular balance between reconstruction quality and steering efficiency. In some implementations of such a method, substantial light may be missing from reconstructed image features. In certain applications (e.g., imaging) and/or for certain device architectures (e.g., dual-modulation), this missing light may lead to reduced efficacy. For example, in the case of dual-modulation the primary modulator is only capable of attenuating the light field, and not of adding energy to it. If this were counteracted by increasing the illumination power, the efficiency of the beam-steering modulation stage may be decreased and/or the cost of the illumination components may be increased. These effects may be avoided by providing a particular wave-propagation loop instead of an increase in illumination power.

The wave-propagation loop operates to establish a bidirectional mapping between the phasor field at the modulation plane M(x, y)=A_{M}(x, y)∠ϕ_{M}(x, y) (also known as a “modulation field”) and the phasor field at the reconstruction plane R(x′, y′)=A_{R}(x′, y′)∠ϕ_{R}(x′, y′) (also known as a “reconstruction field”), where A represents the amplitude component and ∠ϕ represents the phase component. The variables x and y represent pixel coordinates. This bidirectional mapping may be any numerical wave propagation including but not limited to Fresnel or Rayleigh-Sommerfeld methods. The mapping may be denoted by P(M(x, y)) [symbol] R(x′, y′) and its respective converse P⁻¹(R(x′, y′)) [symbol] M(x, y), where P is the wave propagation function. In this example, the modulation plane refers to the plane of the PLM 105 which can only modulate phase, and the reconstruction plane refers to a plane where the reconstruction image is formed, which may be located anywhere between the PLM 105 and the first projection optics 107, i.e. optically downstream PLM 105. The reconstruction plane (or field) is located inside the projector (projector system). The reconstruction plane (or field) R(x′, y′) is located at an optical distance in the near field relative to the modulation plane (or field) M(x, y). In contrast, in conventional Gerchberg-Saxton algorithms, mapping does not occur between two complex planes but rather, for the same definition of the Fourier transform, between a complex plane and infinity, i.e., the far field. Mapping between the modulation plane and the reconstruction plane is more efficient in terms of amount of energy being steered into the right locations of the reconstruction plane compared to mapping between a complex plane and infinity. Definitions of near field and far field optical distances depend on the specific implementation, e.g., the type of PLM, design constraints, etc. For example, in cinema projectors, the near field optical distance may be in the order of a few centimeters or a few tens of centimeters, while a far field optical distance may be in the order of a few meters. In conventional Gerchberg-Saxton algorithms, since mapping is performed via the Fourier transform, mapping is inaccurate in the near field. In an example of the present disclosure, the wave propagation function P mapping the modulation field to the reconstruction field is not a Fourier transform. In a dual-modulation configuration, the reconstruction image is imaged onto the secondary modulator 105′ through the first projection optics 107. In a single-modulation configuration, the reconstruction image is imaged directly onto the screen through the first projection optics 107 and the second projection optics 111.

The modulation field may then be calculated by back-propagating the reconstruction field according to the following expression (1):

P⁻¹(R₀(x′, y′)) [symbol] M₀(x, y) (1)

In expression (1), M₀(x, y)=A_{M0}(x, y)∠ϕ_{M0}(x, y). The modulation field may then be subject to additional processing to account for physical processes or PLM characteristics, such as phase stroke quantization. Before forward-propagating the modulation field to obtain its corresponding reconstruction field, its amplitude-component may be dropped, i.e., may be set to 1, leading to the following expression (2):

P(1∠ϕ_{M0}(x, y) [symbol] R₁(x′, y′) (2)

In expression (2), R₁(x′, y′)=A_{R1}∠ϕ_{R1}. In this iteration, the amplitude-component of the reconstruction field is then typically replaced by the target field, and the cycle repeats again; that is, the resulting field is backwards-propagated resulting in its corresponding modulation field according to the following expression (3):

P⁻¹(\sqrt{I(x′, y′)}∠ϕ_{R1}(x′, y′) [symbol] M₁(x, y) (3)

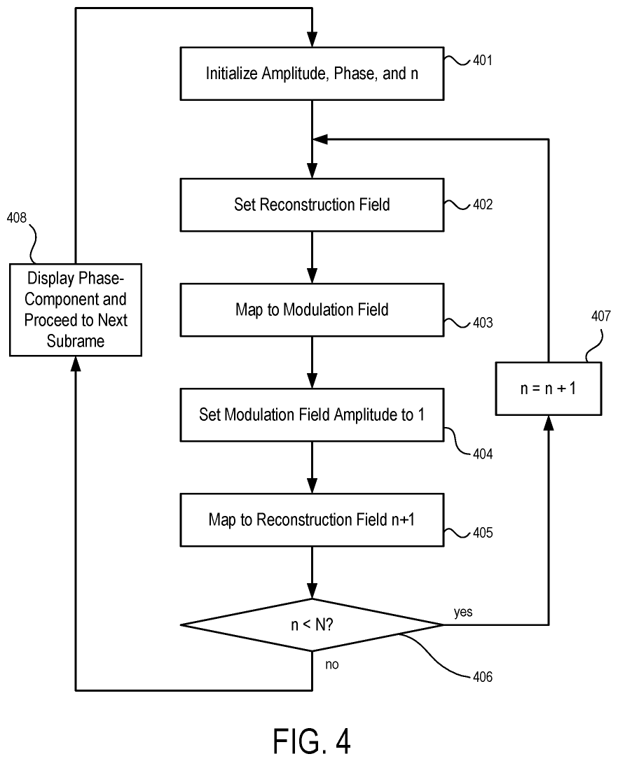

The corresponding modulation field from expression (3) is then subjected to additional processing similar to that described above, its amplitude-component is dropped, and so on. This iterative process repeats, thus forming a wave-propagation loop. This loop may be summarized as illustrated in FIG. 4. To execute the process flow, the projection system 100 may be provided with instructions stored on a non-transitory computer-readable medium (e.g., a hard disk, a removable storage medium, RAM, and so on) which, when the instructions are executed by the controller 114, cause the projection system 100 to perform the operations of FIG. 4.

At operation 401, the amplitude, phase, and an index variable n (which may, for example, indicate the current iteration) are initialized for a frame of image data. For example, the amplitude A_{R0}(x′, y′) is initialized to \sqrt{I(x′, y′)}, the phase ϕ_{R0}(x′, y′) is initialized to some initial value (e.g., a value near the expected phase, a random or pseudo-random seed, etc.), and the index n is set to 0. The iterative wave-propagation loop is then performed, including several operations. At operation 402, the reconstruction field Rₖ(x′, y′) is set to A_{R0}(x′,y′)∠ϕ_{Rk}(x′, y′). Next, at operation 403, the reconstruction field is mapped to the modulation field using expression (1). Note that the subscript 0 in expression (1) here corresponds to the index n, which is 0 for the first iteration in the loop. At operation 404, the amplitude component of the modulation field is set to a predetermined value. For example, the amplitude component of the modulation field may be set to 1. At operation 405, the resulting field is mapped to the reconstruction field for the next iteration using expression (2). In expression (2), the subscripts 0 on the left and 1 on the right indicate the index n, which is 0 for the first iteration in the loop and 1 for the next iteration in the loop. The loop is repeated for n=0 . . . N, where N is the number of iterations. In some examples N may be predetermined; however, in other examples the number of iterations may be dynamically determined. That is, the iterative loop may be automatically terminated (e.g., when the reconstruction field achieves or exceeds a target quality. Thus, at operation 406, the index n is compared to the value N. If n<N, the index n is incremented at operation 407 and the loop begins again with operation 402. If n=N, the phase-component of the modulation field (as described above) is displayed on the PLM as to apply a spatially-varying phase modulation to the second light 104. The method then proceeds to the next frame through operation 408 and begins again at operation 401 for the new frame or subframe, depending on whether the current subframe being processed is the last subframe within a given frame.

### Iterative Regularization

The wave-propagation loop described above may be modified to speed up convergence and/or increase the final quality of the reconstruction field. These effects may be realized by implementing a regularization factor, which adjusts the target amplitudes of the subsequent iteration with the feedback of the reconstruction error ε(x′, y′) from the current iteration. Regularization may provide improved reconstruction image quality at the cost of only a very small increase in computational complexity (e.g., corresponding to the overhead of the regularization factor). The reconstruction error for a given subframe n is given by the following expression (4):

ε(x′, y′)=\sqrt{(x′, y′)}−Aᵣₙ(x′, y′) (4)

A gain function γ(ε(x′, y′)) may also be defined using, as two examples, the following expressions (5a) or (5b):

γ(ε(x′, y′))=sign(ε(x′, y′))·|ε(x′, y′)|^{β} (5a)

γ(ε(x′, y′))=β·G(|ε(x′, y′)|) (5b)

In expressions (5a) and (5b), β is a gain factor. In expression (5b), a blurring filter G (e.g., a Gaussian filter) is applied. The regularization operation may then be performed for the subsequent subframe n+1 according to the following expressions (6a) or (6b):

A_{R,n+1}(x′, y′)=\sqrt{I(x′,y′)}+γ(εₙ(x′, y′)) (6a)

A_{R,n+1}(x′, y′)=A_{R}(x′,y′)+γ(εₙ(x′, y′)) (6b)

Herein, regularization using expression (6a) is referred to as a “first regularization” method and regularization using expression (6b) is referred to as a “second regularization” method.

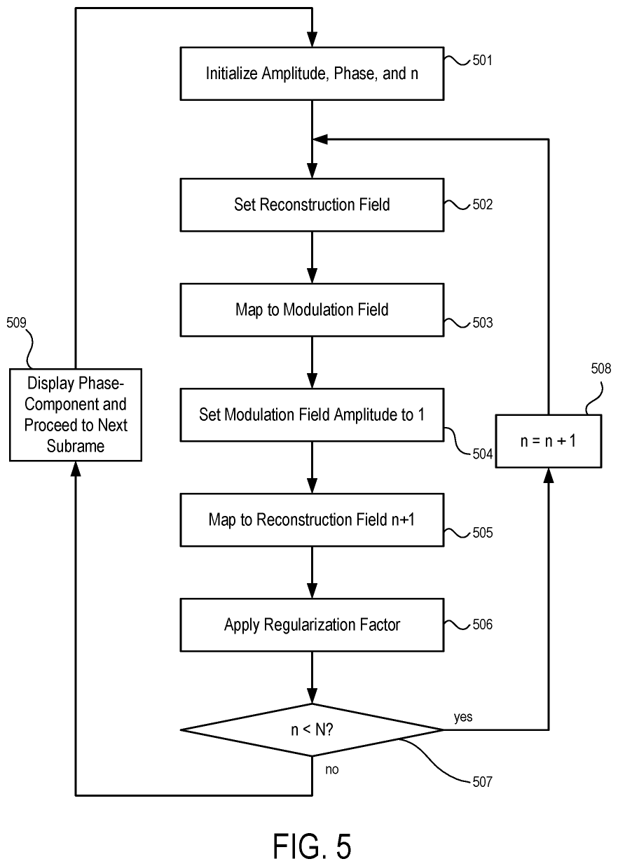

To implement regularization, the method illustrated in FIG. 4 may be modified. FIG. 5 illustrates one exemplary method including regularization. To execute the process flow, the projection system 100 may be provided with instructions stored on a non-transitory computer-readable medium (e.g., a hard disk, a removable storage medium, RAM, and so on) which, when the instructions are executed by the controller 114, cause the projection system 100 to perform the operations of FIG. 5.

At operation 501, the amplitude, phase, and an index variable n (which may, for example, indicate an iteration) are initialized for a frame of image data. For example, the amplitude A_{R0}(x′, y′) is initialized to \sqrt{I(x′, y′)}, the phase ϕ_{R0}(x′, y′) is initialized to some initial value (e.g., a value near the expected phase, a random or pseudo-random seed, etc.), and the index n is set to 0. The iterative wave-propagation loop is then performed, including several operations. At operation 502, the reconstruction field Rₖ(x′, y′) is set to A_{R0}(x′, y′)∠ϕ_{Rk}(x′, y′). Next, at operation 503, the reconstruction field is mapped to the modulation field using expression (1). At operation 504, the amplitude component of the modulation field is set to a predetermined value. For example, the amplitude component of the modulation field is set to 1. At operation 505, the resulting field is mapped to the reconstruction field for the next iteration using expression (2). At operation 506, a regularization factor is applied using, for example, expression (6a) in the first regularization method or expression (6b) in the second regularization method. The loop is repeated for n=0 . . . N, where N is the number of iterations. Thus, at operation 507, the index n is compared to the value N. If n<N, the index n is incremented at operation 508 and the loop begins again with operation 502. If n=N (whether N is predetermined or dynamically determined as described above), the phase-component of the modulation field (as described above) is displayed on the PLM as to apply a spatially-varying phase modulation to the second light 104. The method then proceeds to the next frame through operation 509 and begins again at operation 501 for the new frame or subframe, depending on whether the current subframe being processed is the last subframe within a given frame.

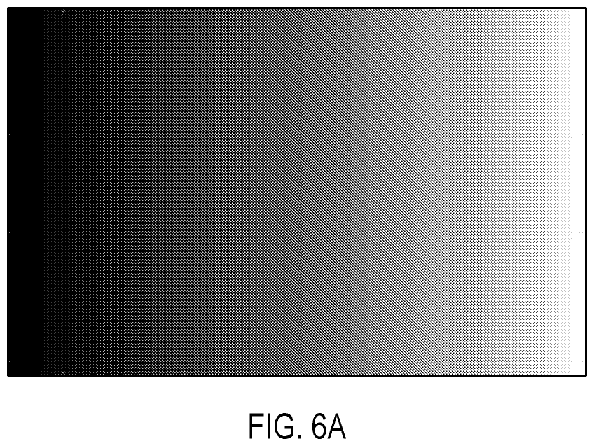

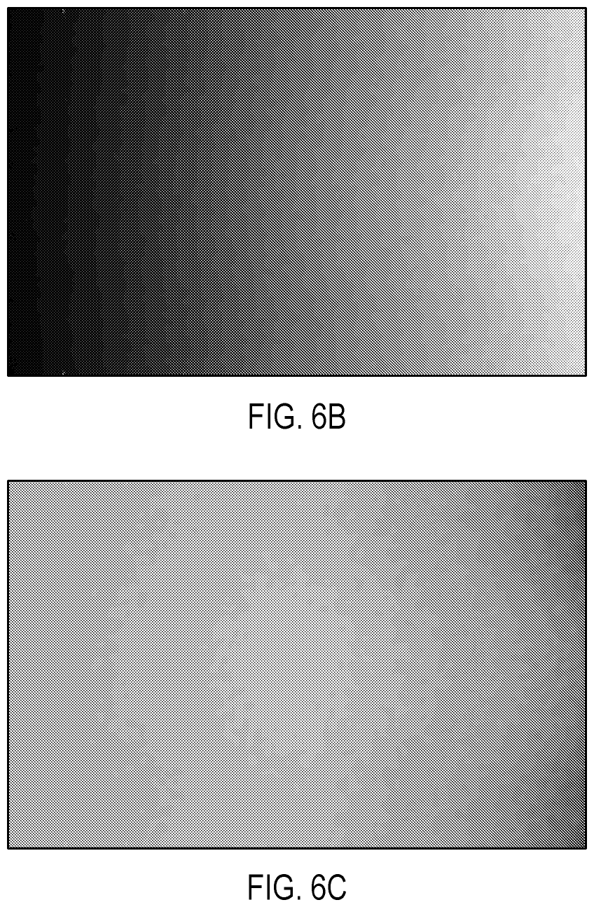

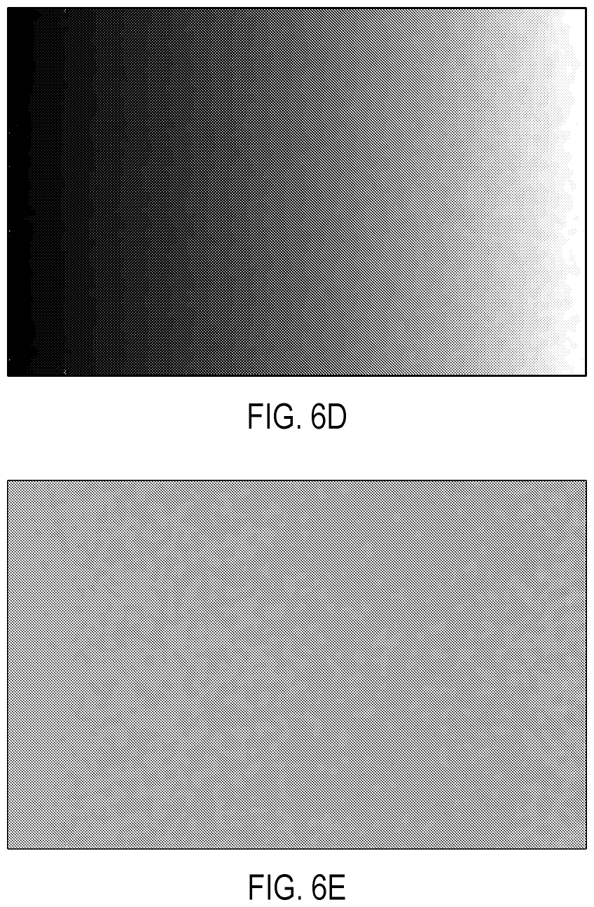

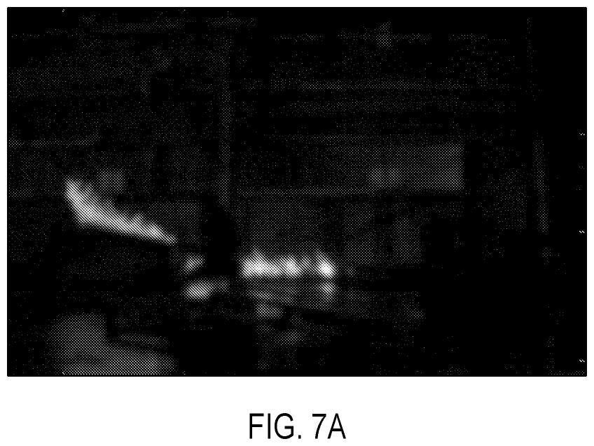

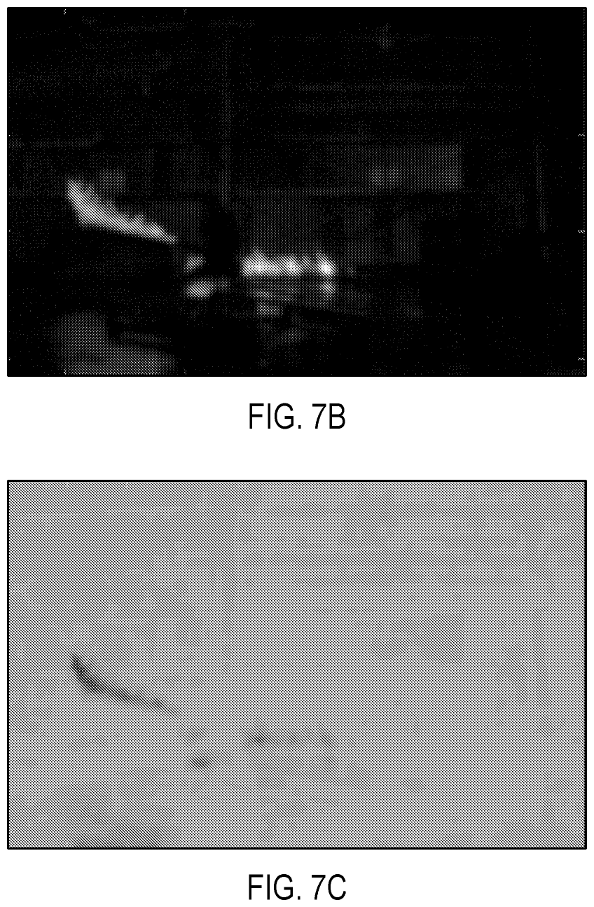

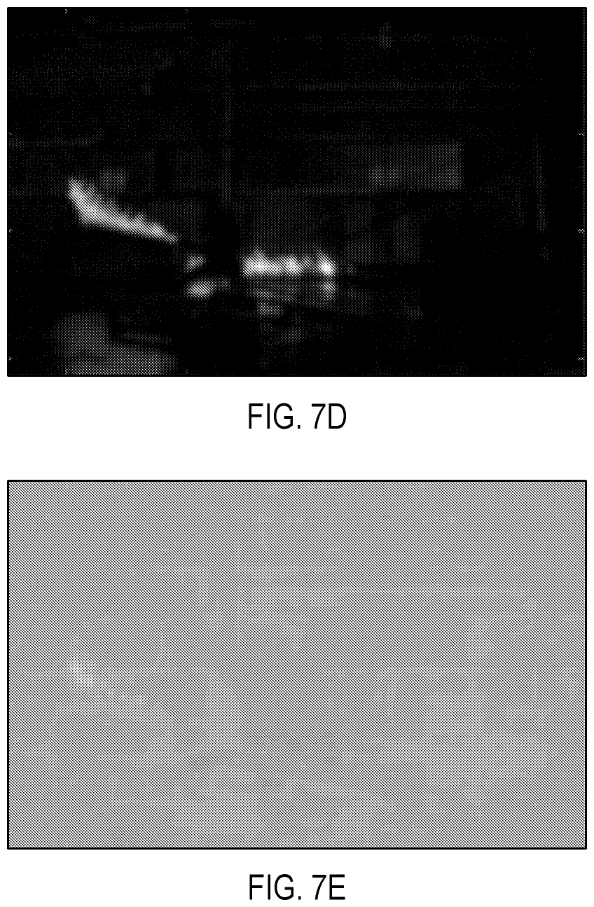

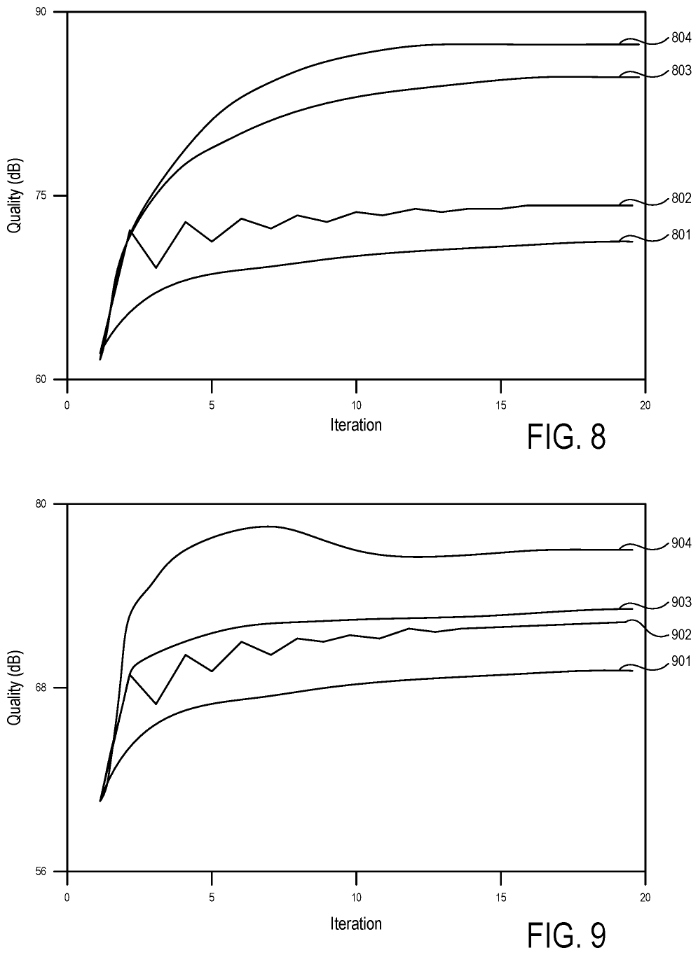

The effects of the wave-propagation loop and of regularization on convergence speed and image quality are illustrated in FIGS. 6A-6E, 7A-7E, 8, and 9. FIGS. 6A-6E respectively illustrate image frames for a ramp image, FIGS. 7A-7E respectively illustrate image frames for a video still, FIG. 8 illustrates a convergence graph for the ramp image, and FIG. 9 illustrates a convergence graph for the video still.

FIGS. 6A and 7A illustrate target images. In the target image of FIG. 6A, a ramp image is shown, which smoothly increases in brightness from the left column of pixels to the right column of pixels. The ramp image is uniform in the vertical direction, such that it does not change from the top row of pixels to the bottom row of pixels. In the target image of FIG. 7A, the video still includes dark areas and smaller bright areas (flames in the illustrated image).

FIGS. 6B and 7B illustrate reconstructed images with no regularization, and FIGS. 6C and 7C are difference maps showing the differences between FIG. 6A and FIG. 6B and between FIG. 7A and FIG. 7B, respectively. FIGS. 6D and 7D illustrate reconstructed images with the second regularization method and a gain factor β of 1.4, and FIGS. 6E and 7E are difference maps showing the differences between FIG. 6A and FIG. 6D and between FIG. 7A and FIG. 7D, respectively. In the difference maps of FIGS. 6C, 6E, 7C, and 7E, darker areas (e.g., on the right side of FIG. 6C) indicate missing energy and lighter areas (e.g., near the center of FIG. 6C) indicate excess energy. In FIGS. 6A-7E, the target images and reconstruction images are blurred to facilitate a visual comparison, as the reconstruction image exhibits speckle due to the coherent nature of the wave propagation in combination with the comparatively low resolution of the PLM and the use of a diffraction-aware phase retrieval algorithm.

FIGS. 6C and 7C show regions corresponding to bright areas of FIGS. 6A and 7A, respectively, and regions corresponding to some dark areas of FIGS. 6A and 7A, respectively. This indicates that, in the absence of a regularization operation, the wave-propagation loop may result in an energy deficiency for bright target image regions and an energy excess for dark target image regions. In other words, in the absence of a regularization operation, the dynamic range of the reconstructed image may be dulled or flattened. FIG. 6E and 7E, by comparison, are more uniform. This indicates that the regularization operation results in a truer reproduction of the target image in the reconstructed image.

To assess the conversion quality (represented by the y axes in FIGS. 8-9, in dB), the reconstruction image is compared with the target image at each iteration of the wave-propagation loop (represented as the x axes in FIGS. 8-9) by means of the peak signal-to-noise ratio (PSNR) metric. In these illustrations, due to the speckle nature of the reconstruction image, both the target and reconstruction images are blurred to enable the use of PSNR as a similarity metric.

In FIG. 8, the ramp image is compared for a first loop method 801, in which no regularization is performed; a second loop method 802, in which the first regularization is performed with a gain factor β of 1.0; a third loop method 803, in which the second regularization is performed with a gain factor β of 1.0; and a fourth loop method 804, in which the second regularization is performed with a gain factor β of 1.4. In each method, the reconstruction quality generally increases along with each iteration. It can be seen that the first regularization method (second loop method 802) provides higher quality than no regularization (first loop method 801), and that the second regularization method (third loop method 803 or fourth loop method 804) provides higher quality than the first regularization method. Moreover, it can be seen that, when using the second regularization method, a gain factor β of 1.4 provides higher quality than a gain factor β of 1.0.

In FIG. 9, the video is compared for a first loop method 901, in which no regularization is performed; a second loop method 902, in which the first regularization is performed with a gain factor β of 1.0; a third loop method 903, in which the second regularization is performed with a gain factor β of 1.0; and a fourth loop method 904, in which the second regularization is performed with a gain factor β of 1.4. In each method, the reconstruction quality generally increases along with each iteration, although the fourth loop method 904 may provide the highest quality with a smaller number of iterations. In some implementations using the fourth loop method 904, the number of iterations may be between five and ten; for example, seven. It can be seen that the first regularization method (second loop method 902) provides higher quality than no regularization (first loop method 901), and that the second regularization method (third loop method 903 or fourth loop method 904) provides higher quality than the first regularization method. Moreover, it can be seen that, when using the second regularization method, a gain factor β of 1.4 provides higher quality than a gain factor β of 1.0. To address the apparent drop in quality after a certain number of iterations in the fourth loop method 904, the iterative loop may be configured to terminate once the maximum quality is achieved. Moreover, the gain function γ and/or the gain factor β may be fine-tuned to the particular application. In a dual-modulation configuration, any instances of overshoot caused by regularization (e.g., the small bright portions of FIG. 7E) may be attenuated by the primary modulator.

The wave-propagation loop with iterative regularization produces phase configurations that reproduce the relative intensities in the reconstructed light field. In some implementations, this may be produced under the assumption that the integrality of the illumination is steered to the primary modulator to make up the reconstruction light field, and the burden of dimming excess light is thus placed on the primary modulator. For certain applications (e.g., for high dynamic range image projection), the light field is dimmed to meet the limited contrast ratio of the primary ratio. This dimming may be achieved by providing a filter, by globally dimming the illumination. or by using a beam-steering dump.

### Beam-Steering Dump

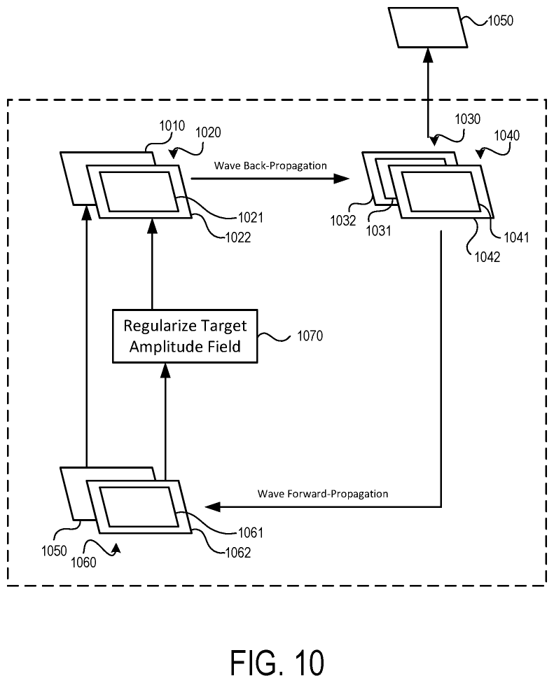

A beam-steering dump may be implemented as part of the wave-propagation loop. In such an implementation, the beam-steering dump allows the wave-propagation loop to converge to a phase configuration that steers any excess energy into the dump region, while achieving the absolute intensity levels within the reconstruction image. Moreover, the beam-steering dump region operates as a float region inside which the values are unconstrained and free to fluctuate; therefore, the float region relaxes the constraints within the wave-propagation loop, which may allow convergence onto a solution. FIG. 10 illustrates an exemplary wave propagation loop with a beam-steering dump region.

Each image in the loop illustrated in FIG. 10 is broken up into its phase component and its amplitude component. For example, the loop initiates with a target image Rₙ(x′, y′) which includes an initial reconstruction phase field 1010, which may be represented as ϕ_{Rn}(x′, y′), and an initial reconstruction amplitude field 1020, which may be represented as A_{Rn}(x′,y′). The phase ϕ_{R0}(x′, y′) 1010 is initialized to some initial value (e.g., a value near the expected phase, a random or pseudo-random seed, etc.) and the index n is set to 0. The amplitude A_{R0}(x′, y′) 1020 is initialized to \sqrt{I(x′, y′)} within an active region 1021 and is padded with a dump region 1022. In some implementations, the particular value of virtual pixels (i.e., pixels which do not necessarily correspond to image data) in the dump region 1022 may not significantly affect the convergence of the loop, and thus may be set to a predetermined value such as zero, another empirical constant value, a value that is calculated (e.g., from the illumination APL and target image APL), a random value, or combinations thereof.

After back-propagation, the resulting modulation field Mₙ(x, y) includes a phase component 1030, which may be represented as ϕ_{Mn}(x, y), and an amplitude component 1040, which may be represented as A_{Mn}(x, y). Both the phase component 1030 and the amplitude component 1040 of the modulation field include an addressable region (1031 and 1041, respectively) and an unaddressable region (1032 and 1042, respectively). The unaddressable regions 1032 and 1042 are outside of the modulation region of the PLM 105 and therefore may be set to zero. At this point in the loop, values in the addressable region 1041 (the amplitude component 1040 of the modulation field) may be set to the flat level intensity (in nits) of the illumination \sqrt{Kᵢₗₗᵤₘ} (i.e., the square root of the illumination intensity, which may be a single value or a 2D map and may be treated as a constant). Setting the regions to these values imposes a relationship between the amplitude values at the modulation field and the amplitude values at the reconstruction field. This may enable the loop to automatically converge onto a reconstruction field in which the values within the active region 1021 approximate the target absolute levels, and the values within the dump region 1022 contain any excess energy due to (for example) the target image uses less energy than what is provided by the light source.

At the n=N iteration, the addressable region 1031 of the phase component 1030 of the modulation field are output as an interim phase-component 1050 (e.g., a phase configuration 1050) for the PLM 105. Otherwise, after forward-propagation the loop produces a reconstruction field Rₙ₊₁(x′, y′) which includes interim phase-component 1050, which may be represented as ϕ_{R,n+1}(x′, y′), and an interim amplitude-component 1060, which may be represented as A_{R,n+1}(x′, y′). The active region 1061 of the interim amplitude-component 1060 may then be subjected to regularization 1070, while the dump region 1062 of the interim amplitude-component 1060 may be left untouched. The regularization 1070 may use the first regularization method (i.e., using expression (6a)) or the second regularization method (i.e., using expression (6b)). The interim phase-component 1050 and the interim amplitude-component 1060, which includes the active region 1061 (after regularization) and the dump region 1062, are then used, in respective order, as initial reconstruction phase field 1010 and an initial reconstruction amplitude field 1020, which includes the active region 1021 and the dump region 1022, for the next iteration through the loop. During the forward-propagation and regularization, values within the various dump regions may be unprocessed and thus left untouched.

While FIG. 10 illustrates the various dump regions as fully enclosing the corresponding image region (e.g., the dump region 1022 fully enclosing the image region 1021), the present disclosure is not so limited. In some implementations, the dump region may only be present as stripes above and below the image region, such that the corresponding image (e.g., the initial reconstruction amplitude field 1020) is square. This configuration may improve computational efficiency. For example cinema images do not have a 1:1 aspect ratio but certain operations (e.g., fast Fourier transforms or FFTs) operate most efficiently with square matrices. Thus, by padding the rectangular image region with target regions above and below, the resultant image is made to have a 1:1 aspect ratio. Moreover, while FIG. 10 illustrates the dump region as being a region external to the corresponding image region (i.e., an out-of-image region), the operations of FIG. 10 may also be implemented with an optical DC or Fourier filter. These operations may be implemented in both single- and multi-stage modulation image projection systems employing a beam-steering device (e.g., the PLM 105) with slow and fast response times. In the case of a comparatively-slow PLM 105 (e.g., an LCOS-type device), the operations of FIG. 10 allow for the calculation of one or a small number of high-quality phase configurations per video frame, depending on the frame rate of the PLM 105. In the case of a comparatively-fast PLM 105 (i.e., a MEMS-type device), the operations of FIG. 10 allow for the calculation of a single high quality phase configuration per video frame, where the phase configurations of the remaining subframes in the frame may be generated from the already-computed phase configuration, at least because for each video frame the corresponding subframe phase configurations are speckle-variations of one another. This may provide for increased computational efficiency as compared to methods which utilize the integration of different subframe solutions to achieve a video frame image.

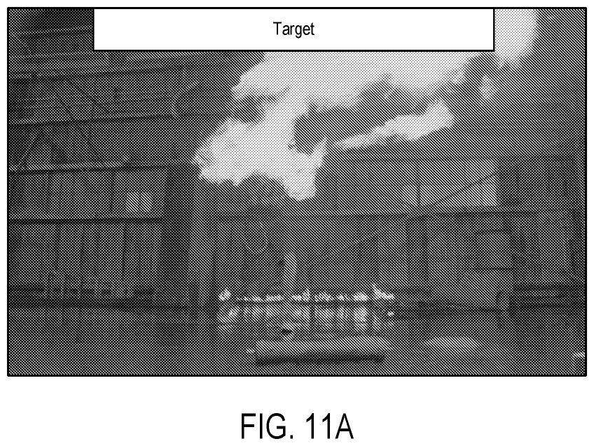

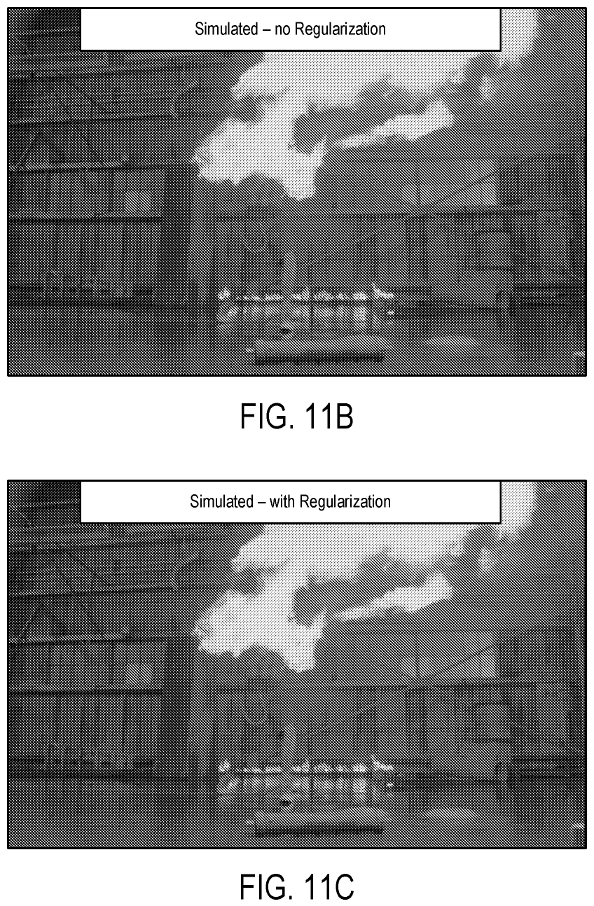

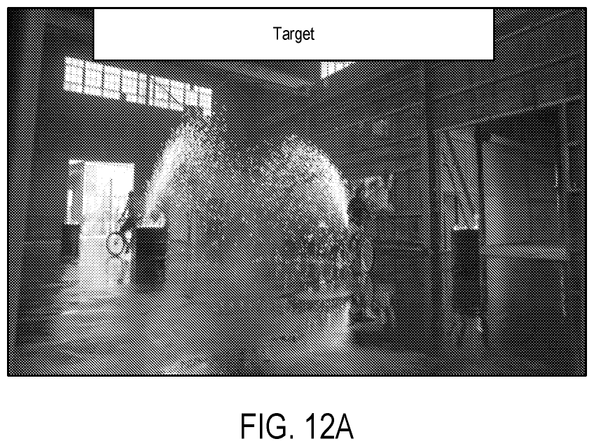

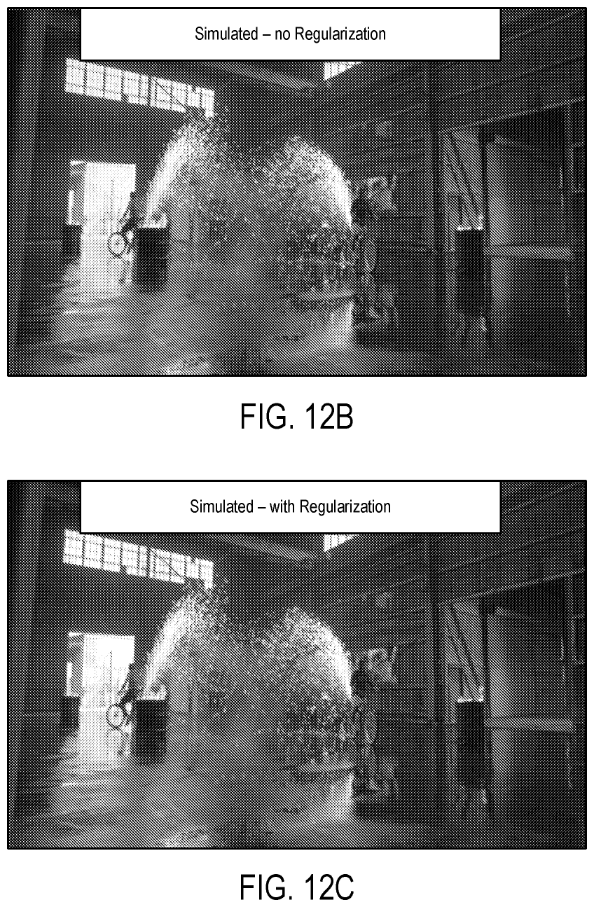

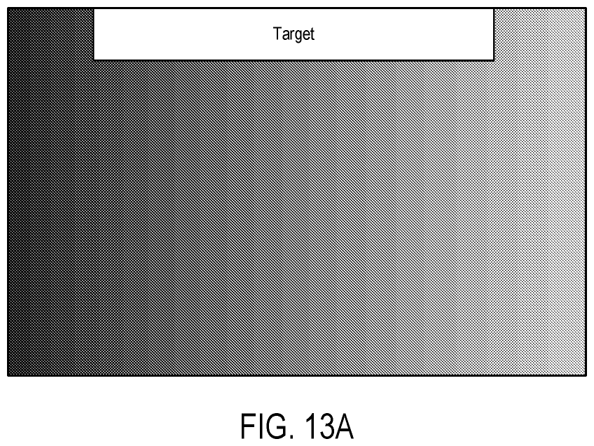

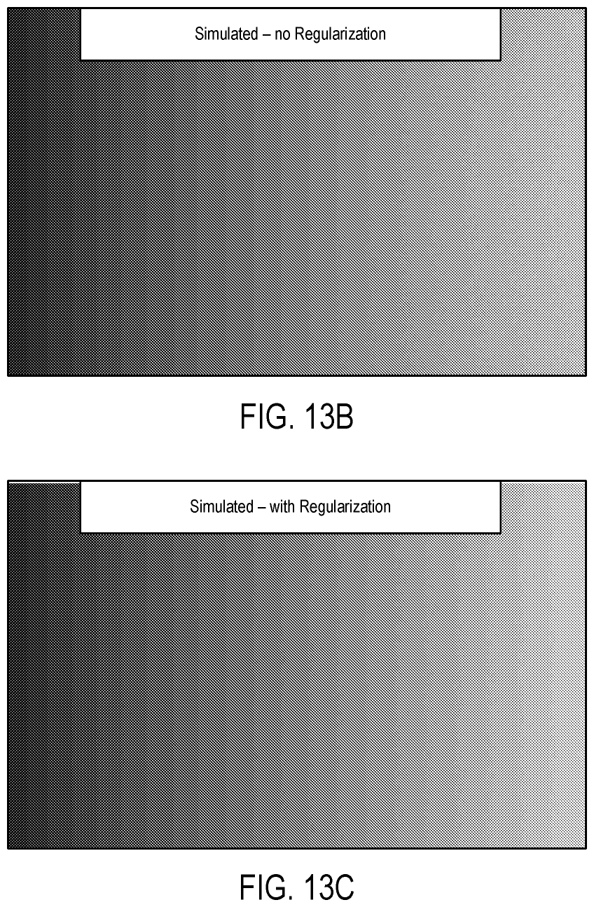

FIGS. 11A-11C, 12A-12C, and 13A-13C respectively illustrate simulations of on-screen reconstructions (i.e., a single frame produced using a comparatively-slow beam-steering device) in a dual-modulation beam-steering system and the loop of FIG. 10. For purposes of the simulations, the laser illumination is treated as having a flat level of 27 nits. FIGS. 11A-11C and 12A-12C respectively illustrate simulations for a video still, and FIGS. 13A-13C respectively illustrate simulations for a ramp image (e.g., the ramp image described above with regard to FIGS. 6A-6E).

FIG. 11A illustrates a target image for a video still including dark areas and bright areas (flames in the illustrated image). FIG. 11B illustrates a simulated screen image with no regularization, and FIG. 11C illustrates a simulated image with regularization. In particular, the simulation of FIG. 11C was generated using the second regularization method and a gain factor β of 1.4 with a light dump. Three image portions, each having a different brightness level, were analyzed. The average picture level (APL) of the target image in FIG. 11A is 17.5 nits for bright portions, 12.9 nits for mid-level portions, and 5.9 nit for dark portions. The APL of the simulated image in FIG. 11B is 17.2 nits for bright portions, 12.7 nits for mid-level portions, and 5.8 nits for dark portions. In contrast, the APL of the simulated image in FIG. 11C is 17.5 nits for bright portions, 12.9 nits for mid-level portions, and 5.9 nits for dark portions. Thus, through the use of a light dump and regularization, the simulated image of FIG. 11C more closely approximates the target image compared to the simulated image of FIG. 11B.

FIG. 12A illustrates a target image for a video still including dark areas and bright areas (sparks or lit windows in the illustrated image). FIG. 12B illustrates a simulated screen image with no regularization, and FIG. 12C illustrates a simulated image with regularization. In particular, the simulation of FIG. 12C was generated using the second regularization method and a gain factor β of 1.4 with a light dump. Three image portions, each having a different brightness level, were analyzed. The APL of the target image in FIG. 12A is 12.8 nits for bright portions, 11.8 nits for mid-level portions, and 8.7 nit for dark portions. The APL of the simulated image in FIG. 12B is 12.2 nits for bright portions, 10.8 nits for mid-level portions, and 8.6 nits for dark portions. In contrast, the APL of the simulated image in FIG. 12C is 12.7 nits for bright portions, 11.1 nits for mid-level portions, and 8.7 nits for dark portions. Thus, through the use of a light dump and regularization, the simulated image of FIG. 12C more closely approximates the target image compared to the simulated image of FIG. 12B.

FIG. 13A illustrates a target image for a ramp image increasing in brightness from left to right. FIG. 13B illustrates a simulated screen image with no regularization, and FIG. 13C illustrates a simulated image with regularization. In particular, the simulation of FIG. 13C was generated using the second regularization method and a gain factor β of 1.4. Three image portions, each having the same (high) brightness level, were analyzed. The APL of the target image in FIG. 13A is 18.9 nits for all three portions. The APL of the simulated image in FIG. 13B is 17.8 nits for two of the portions, and 17.5 nits for the other portion. In contrast, the APL of the simulated image in FIG. 13C is 18.8 nits for all three portions two of the portions, and 18.7 nits for the other portion. Thus, through the use of a light dump and regularization, the simulated image of FIG. 13C more closely approximates the target image compared to the simulated image of FIG. 13B.

Dumping large amounts of light into the dump regions may, in some implementations, result in light bleeding into the image region and effectively degrading the image. Although the primary modulator functions to increase the effective contrast ratio of the beam-steered light field, the primary modulator also provides some light-dumping capabilities. Therefore, the wave-propagation loop may be adjusted such that it automatically converges onto a solution that dumps excess light by using both the dump regions and the primary modulator. Such an adjustment may include modifying the regularization expression such that it makes the wave-propagation loop aware of the primary modulator's capabilities (i.e., its contrast ratio), thereby allowing it to produce more accurate phase configurations that interchangeably use the dump region and the primary modulator leading to better on-screen image absolute levels.

A contrast-awareness function may be defined using the following expression (7):

$$C ( {x}^{′} , {t}^{′} ) = clip ( \frac{I ( {x}^{′} , {y}^{′} )}{{{A}_{rn} ( {x}^{′} , {y}^{′} )}^{2}} , \frac{1}{c} , 1. ) \qquad ( 7 )$$

In expression (7), c represents the contrast ratio of the primary modulator and the function clip (X, A, B) represents a clipping function which clips the value of X to be in the interval [A, B]. As a result, the reconstruction error for a given subframe n becomes the following expression (8):

ε(x′, y′)=\sqrt{I(x′, y′)}−\sqrt{C(x′, y′)·Aᵣₙ(x′, y′)²} (8)

Expression (8) may be used for the error in the gain function of expression (5b) instead of expression (4). This will make the regularization operation of (6b) aware of the contrast ratio of the primary modulator and thus provide the above-noted benefits.

### Global Feedback

Some open-loop integration schemes feed the phase algorithm the same input image for every subframe and use the randomness of each individual solution to integrate into an image having less noise (e.g., a higher SNR). In some examples, up to 100 individual solutions (or more) may be generated, each for a corresponding subframe within a frame. Even if, for example, a diffraction-aware algorithm is used, each subframe tends to exhibit roll-off toward the edges of the frame and may exhibit randomness; thus, the resulting integrated light field exhibits roll-off and may present an image with increased blurring and reduced contrast. These effects occur in addition to the level issues (e.g., overshoot and undershoot) for individual solutions described above.

In practice, it may be difficult or impossible to predict the exact outcome of a diffraction-aware phase algorithm, especially when using a random phase distribution as an initial state. However, integrating many solutions for the same image may provide information regarding the phase algorithm itself. As such, it may be possible to use the results of previous integrations to correct for deficiencies in subsequent integrations, and thereby achieve a more accurate target image. This may be accomplished using a feedback loop acting on the intensities fed into the phase algorithm for each sub-frame. In one example, the feedback loop is applied outside of and independent from the phase algorithm itself, referred to as “outer-loop feedback” or OLFB. OLFB may be used in addition to other iterative methods such as wave-propagation or iterative regularization, or may be used by itself.

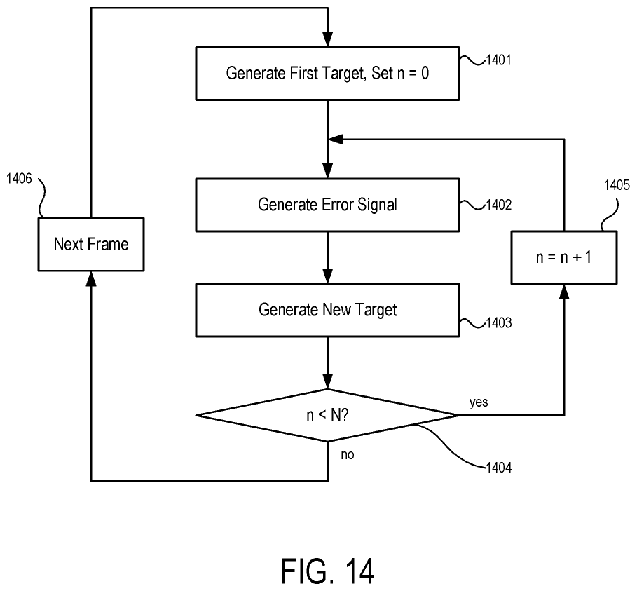

The OLFB method may be implemented by performing a series of operation for each integration within a subframe except for the first integration. One example of an OLFB method is illustrated in FIG. 14. At operation 1401, the first target is generated for a given frame, and the index variable n (corresponding to the number of the current subframe) is set to 0. At operation 1402, the current integrated lightfield simulation i_{LFS} is compared with the target image T to generate a two-dimensional error signal E. This may be represented by the following expression (9):

E=c₁(T)−c₂(i_{LFS}) (9)

In expression (9), c₁ and c₂ are conditioning functions. Next at operation 1403, the error signal is combined with the input intensities to generate a new target T′ for the phase algorithm. This may be represented by the following expression (10):

I′=I+g(E) (10)

In expression (10), g is a conditioning function. The conditioning functions c₁ and c₂ scale their respective arguments T and i_{LFS} so they both have the same total energy. The conditioning function g applies a gain to the error to amplify the correction and speed the convergence. The error signal E and the target intensities T′ are updated for each subframe n=1 . . . N, where N is the number of subframes or integrations in a frame, using results from the previous iteration or from multiple previous iterations. Thus, at operation 1404, the index n is compared to the value N. If n<N, the index n is incremented at operation 1405 and the loop begins again with operation 1402. If n=N, the method proceeds to the next frame through operation 1406 and begins again at operation 1401 for the new frame. The total number of iterations N may be chosen to balance image quality and computational requirements. In some implementations, N≥6. In one example, N=6.

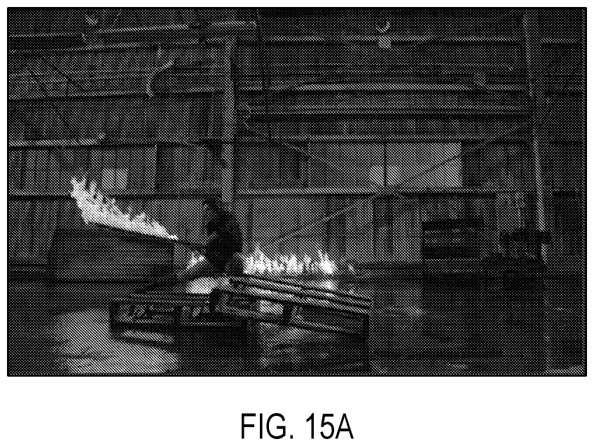

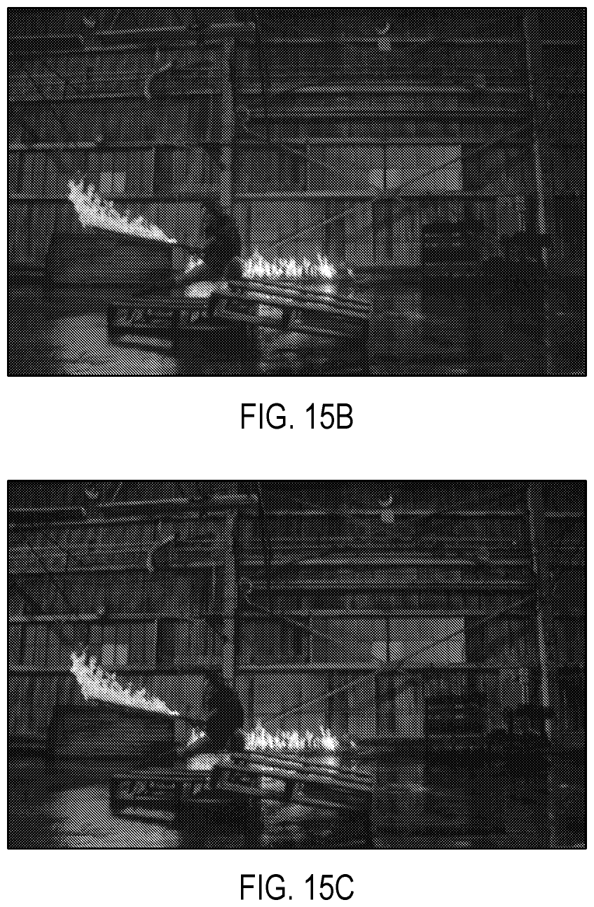

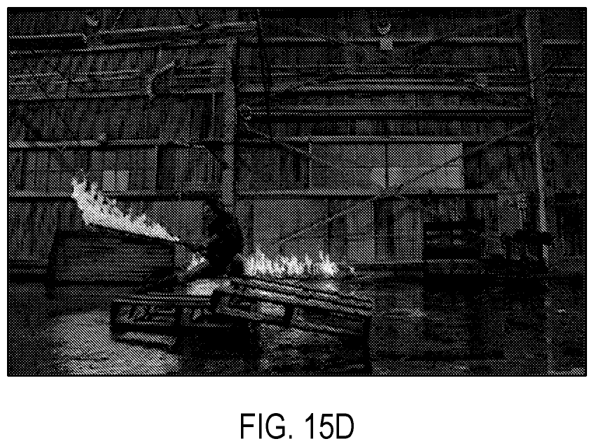

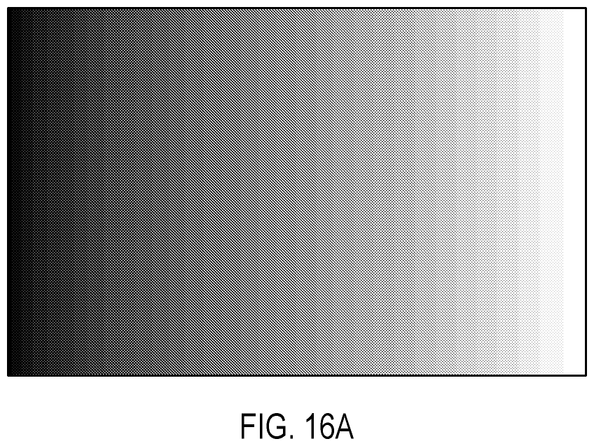

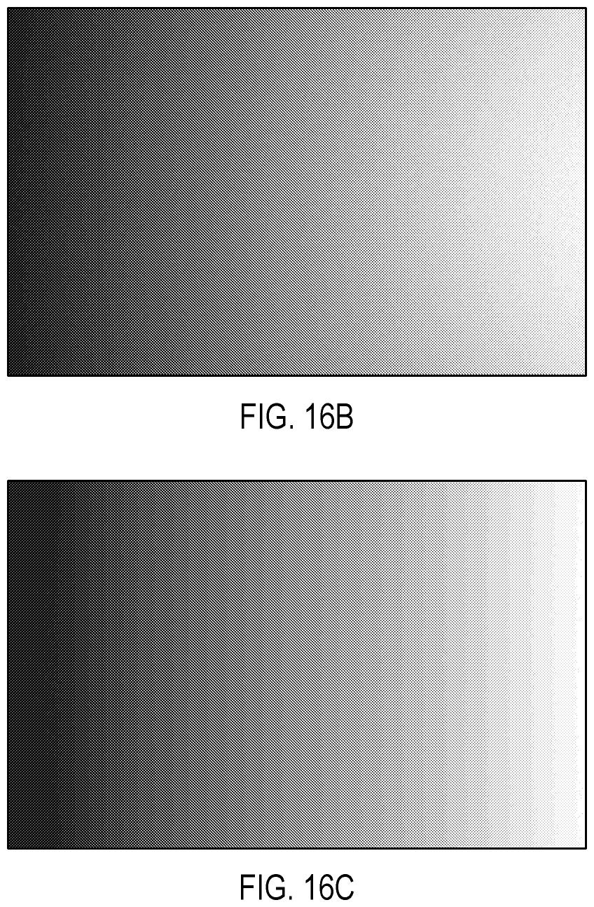

The effects of the OLFB as compared to an open-loop method are illustrated in FIGS. 15A-15D, 16A-16C, 17A-17B, and 18. FIGS. 15A-15D respectively illustrate image frames for a video still; and FIGS. 16A-16C, 17A-17B, and 18 respectively illustrate image frames and graphical analyses for a ramp image (e.g., the ramp image described above with regard to FIGS. 6A-6E and/or FIGS. 13A-14C). The illustrations are presented without a PSF applied.

FIG. 15A illustrates a target image frame, which includes dark areas and smaller bright areas (flames in the illustrated image). FIG. 15B illustrates an integrated image produced by an open-loop method using a diffraction-aware algorithm, integrating N=100 solutions. By comparing FIG. 15B with FIG. 15A, it can be seen that the open-loop method produces an integrated image which exhibits roll-off toward the edges of the frame, is blurred, and has lower contrast.

FIG. 15C illustrates an integrated image produced by the OLFB method described above, integrating N=100 solutions. By comparing FIG. 15C with FIG. 15B, it can be seen that the OLFB method produces an integrated image of higher quality which more accurately approximates the target image of FIG. 15A, especially at the corners and edges. While not necessarily caused only by a single factor, one reason for this is because later subframes take into account the errors of earlier subframes, and thus are particularly generated to counteract these errors. For example, FIG. 15D illustrates the target image for the final integration (n=100). By comparing FIG. 15D with FIG. 15B, it can be seen that the OLFB method in later iterations amplifies all of the regions where the open-loop method is light-deficient.

FIG. 16A illustrates a target image for a ramp image increasing in brightness from left to right. FIG. 16B illustrates an integrated image produced by an open-loop method using a diffraction-aware algorithm, integrating N=100 solutions. By comparing FIG. 16B with FIG. 16A, it can be seen that the open-loop method produces an integrated image which exhibits roll-off toward the edges of the frame, is noisy, and has lower contrast. FIG. 16C illustrates an integrated image produced by the OLFB method described above, integrating N=100 solutions. By comparing FIG. 16C with FIG. 16B, it can be seen that the OLFB method produces an integrated image of higher quality which more accurately approximates the target image of FIG. 16A and which exhibits less noise, especially at the corners and edges.

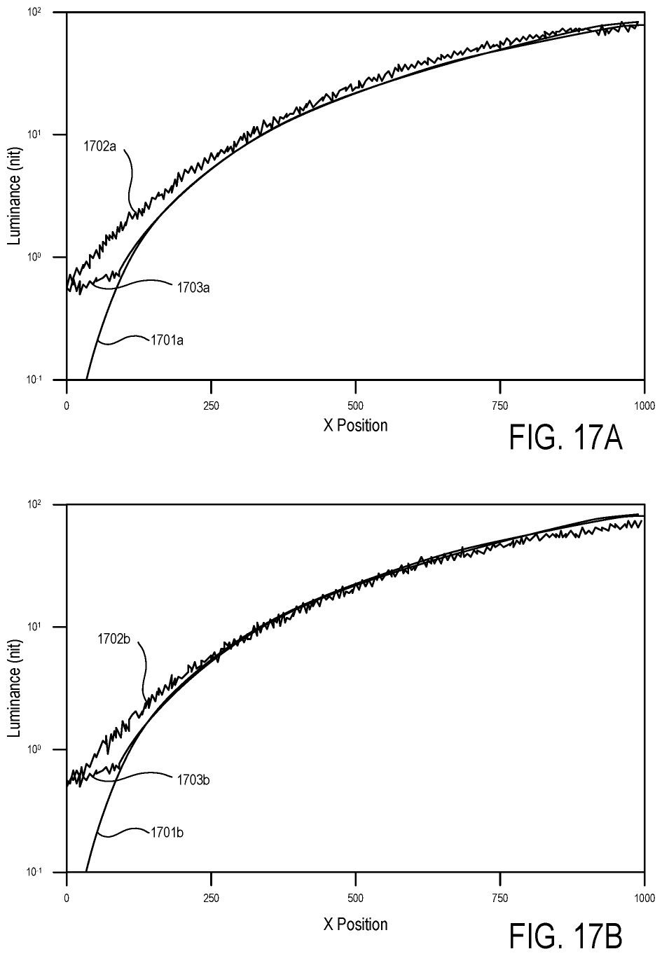

The differences between FIGS. 16A, 16B, and 16C are illustrated in more detail in FIGS. 17A-17B. FIGS. 17A shows the luminance level in nits on the y-axis, in a log scale, vs. the horizontal pixel position on the x-axis for the ramp waveform of FIGS. 16A-16C, for a single row of pixels at approximately the middle of the image. The target image of FIG. 16A is shown as curve 1701a, the open-loop N=100 integrated image of FIG. 16B is shown as curve 1702a, and the OLFB N=100 integrated image of FIG. 16C is shown as curve 1703a. FIG. 17B shows the same information for a single row of pixels near the top of the image. The target image of FIG. 16A is shown as curve 1701b, the open-loop N=100 integrated image of FIG. 16B is shown as curve 1702b, and the OLFB N=100 integrated image of FIG. 16C is shown as curve 1703b. Curves 1703a and 1703b much more closely approximate the target curves 1701a and 1701b, respectively, than do the curves 1702a and 1702b. Moreover, any discrepancies (e.g., for dark pixels near the left of the ramp image) are consistent throughout the image for OLFB, whereas the open-loop method has different degrees of discrepancy between the top and middle rows of the ramp image.

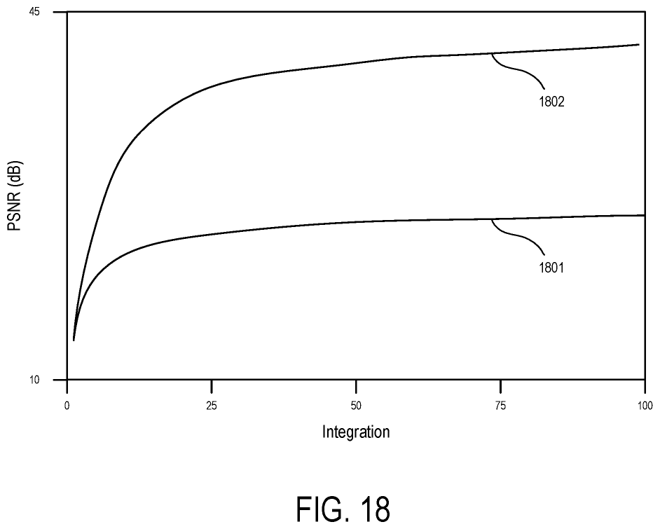

Moreover, OLFB generates a cleaner and more accurate image compared to the open-loop method. This can be seen by the lower amount of noise in curves 1703a and 1703b compared to the curves 1702a and 1702b. This is also illustrated in more detail in FIG. 18, which also shows that the OLFB method converges to a substantially-noise free solution more quickly than the open-loop method. In particular, FIG. 18 illustrates the PSNR in dB on the y-axis and the number of integrations N on the x-axis. The open-loop method is shown as curve 1801, and the OLFB method is shown as curve 1802.

Curve 1802 increases more quickly than curve 1801, and has a much higher maximum value. For example, the y-value of curve 1802 at x=6 is higher than the y-value of curve 1801 at x=100; this indicates that the PSNR of the OLFB method with only six integrations is higher than the PSNR of the open-loop method with 100 integrations. While not illustrated in FIG. 18, the noise level of the OLFB method at approximately 15 integrations is approximately equal to the noise level of the open-loop method at 100 integrations. In other words, the OLFB also provides a reduction in computational complexity. This holds for both phase-only projection systems as well as for multi-modulations systems employing fast phase modulators. For systems using a PSF (e.g., for blurring) between the phase modulator and a downstream modulator, the OLFB can account for the PSF when updating the subframes' targets, and thus realize a form of iterative deconvolution. The net effect is an integrated light field with brighter objects and reduced halo, subject to system brightness limitations.

### OLFB Light Dumping

As noted above, because a PLM can only redirect light (as opposed to discarding it), achieving absolute intensities in the reconstructed image may involve dumping the excess energy by means other than the PLM. In one example, if a Fourier (DC) filter is present in the optical path (e.g., as or with the filter 109), all unmodulated light (i.e., light traveling straight through) after the PLM will be discarded. It is then possible to control the amount of light that reaches the reconstruction plane by limiting the area of the modulator that is used to create the image (referred to as the “active area”). The light in the inactive area of the modulator will then be discarded in the Fourier filter. Additionally or alternatively, it is possible to create a beam-steering dump region around the reconstructed image that will contain the excess energy.

The beam-steering dump region may be implemented using the OLFB method. This may be performed instead of the implementation of the dump region in the iterative regularization process described above. The OLFB method facilitates dumping because, while the diffraction efficiency is not known a priori, it may be calculated (either for the image and dump together, or for either individually) after solving for the first sub-frame and may be updated at each subsequent integration. The diffraction efficiency will generally remain constant across all integrations, despite the target being updated for each subframe. Thus, using the diffraction efficiency of the previous integration to scale the image portion leads to accurate results. In this implementation, the phase algorithm itself does not implement a dumping scheme and instead merely solves for a normalized square target.

In one example, the dump region is implemented as two bands of equal intensities above and below the reconstructed image, making the overall reconstruction window square and thus preserving the steering requirements (i.e., the maximum steering angle is unchanged). Moreover, providing a square reconstruction window reduces computational overhead for the two-dimension FFTs used to simulate diffraction. A gap may be reserved between the dump region and the edges of the image region, thereby to prevent light in the dump from bleeding back onto the image portion when a PSF is used (e.g., for multi-modulation systems). In such an implementation, the image energy may first be scaled up by some estimated diffraction efficiency, and subsequently updated by the actual calculated efficiency value.

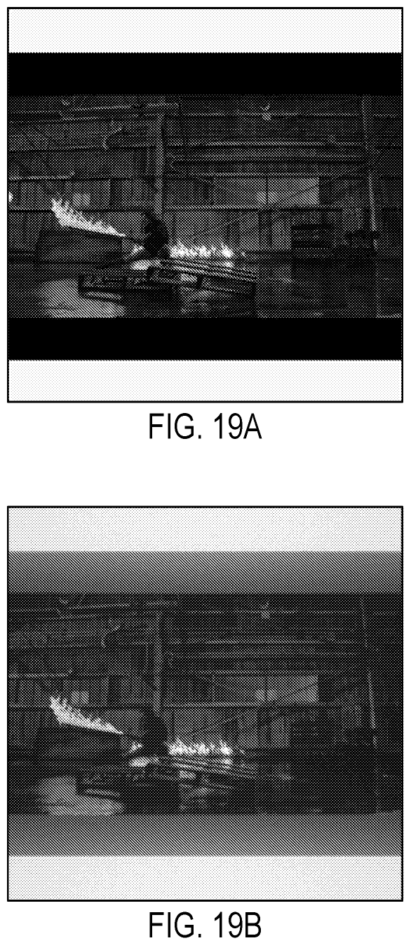

FIGS. 19A-19B illustrate effects of a dump region to generate a square window. FIG. 19A illustrates a target image frame, and FIG. 19B illustrates the resulting integrated light field using OLFB. In FIG. 19A, stripe-shaped light dump regions are positioned at the top and bottom of the window, with stripe-shaped black gap regions between the image region and the dump regions. As a result, the effects of light leakage or bleeding are mainly or entirely confined to the corresponding gap regions in the integrated image of FIG. 19B, and the image region itself remains mainly or entirely unaffected. In some implementations, it may increase computational complexity to implement large black gap regions in the phase algorithm as seen in FIG. 19A. In such situations, the dump regions and gap regions may be replaced with non-linear ramp regions above and below the image region, of increasing brightness with increasing proximity to the upper and lower edges of the reconstruction window.

### Flaring

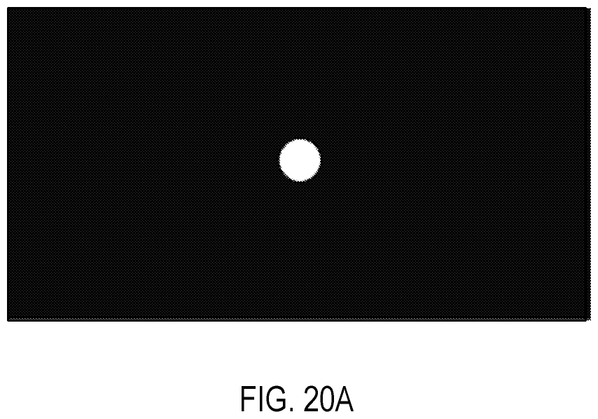

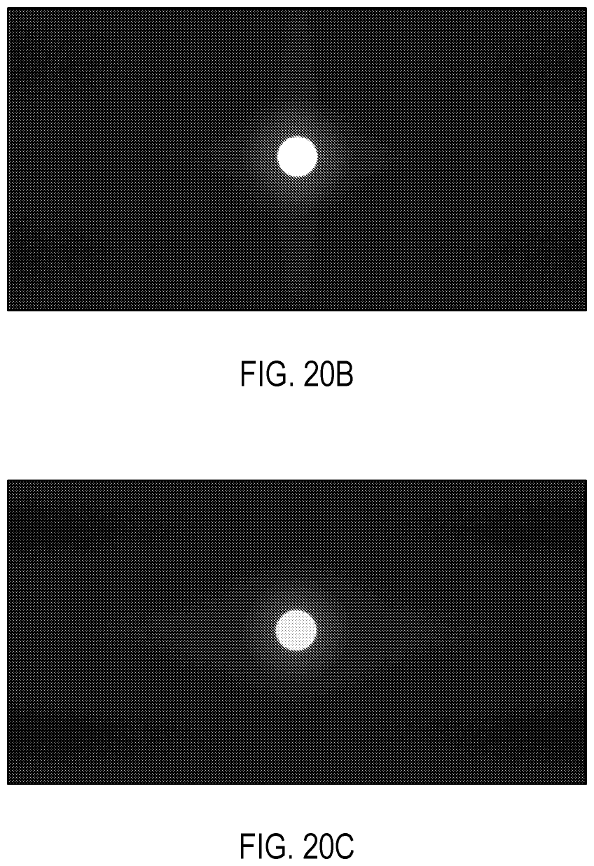

When the target image includes small and very bright features, diffraction-aware phase algorithms may introduce an artifact on screen that manifests as a flare around the object, with a large portion of the energy spreading both horizontally and vertically. Such flaring and the effects of the above algorithms thereon are illustrated in FIGS. 20A-20C.

FIG. 20A illustrates a target image, in which a circle of high luminance is positioned at the center of the image frame and is surrounded by black. FIG. 20B illustrates the reconstructed image corresponding to FIG. 20A, having been subjected to an OLFB method with N=100 and a diffraction-aware phase retrieval algorithm. As can be seen from FIG. 20B, a halo is present around the circle and a vertical stripe of residual brightness is present passing through the circle. Note that, for purposes of illustration, FIGS. 20A-20B use a high gamma value to increase the visibility of the halo and stripe (“flare”) artifacts. Moreover, for this example, the target image does not utilize all of the light; if all the light were utilized, the visibility of the artifacts would be greater.

Without limitation to any one particular mathematical theory, it is believed that the flare effect occurs when the propagation operator, which has a circular lens-like shape, reaches the edge of the modulator and is clipped into a rectangular shape. The brighter the object, the larger the area of the modulator that is allocated for the object; in other words, the larger the “lens.” This true not only for lens-like algorithms, but also for diffraction-aware algorithms. When the “lens” for a bright object hits the aperture of the projection system, its propagation function is multiplied with the corresponding portion of the rectangular aperture. The resulting lightfield generated by the lens, which is the reconstructed object, is thus convolved with the Fourier transform for the rectangular aperture, which is a two-dimensional sinc function. Therefore, the flaring is apparent mostly on the horizontal and vertical axes.

To address the presence of flare, an active area may be defined on the modulator. The active area has a geometric shape whose Fourier transform does not produce strong vertical or horizontal flaring. For example, the active area may be a circle or an ellipse. The active area is used to create the image and, in some implementations, a portion of the dump region. The remaining area (“non-active area”) of the modulator is solely dedicated to steering light into a dump. To achieve this, the method first solves for the dump alone using either the entire modulator or only the non-active area. This may be done in advance (e.g., as part of the system's initialization). The diffraction-aware algorithm is modified to only use the active area of the modulator. The non-active area remains configured with the dump solution throughout the process. The effect of this is to simulate a modulator with the desired geometric shape.

The shape is chosen such that its area is large enough to steer enough energy toward the image. For phase modulators with a 16:9 aspect ratio (i.e., wider than tall), the largest inscribed circle occupies approximately 40% of the area. As such, a circular active area may be appropriate for target images whose energy is less than 40% of the available energy. If the required energy is greater, an elliptical area may instead be chosen. The largest inscribed ellipse occupies approximately 78% of the area, and thus an elliptical active area may accommodate target images whose energy is up to 78% of the available energy.

FIG. 20C illustrates the effect of a method in which the active area was chosen as the largest inscribed circle, and thus may handle up to 40% of the diffuse energy. As can be seen from FIG. 20C, the resulting lightfield exhibits significantly reduced vertical and horizontal flaring as compared to FIG. 20C.

In other implementations, flaring may be addressed through the use of an optical filter located in the Fourier plane of the beam-steered lightfield. This optical filter may resemble a crosshair and block all steering frequencies that are strictly vertical or horizontal. While this may block frequencies that make up the target energy, it will block frequencies corresponding to the flaring effect. The phase configuration may be generated in such a way that strictly horizontal and vertical frequencies are not used to achieve the target image, thereby avoiding the blocking of target energy frequencies. In one example, this is implemented with an angular spectrum filter within the wave-propagation loop that generates the phase configuration.

### Phase Stroke Quantization

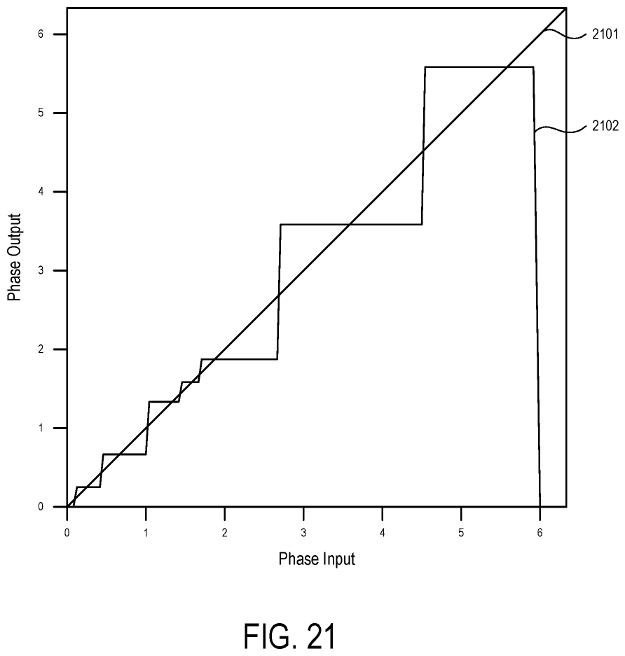

As noted above, the operation of the PLM 105 may be affected by factors including phase stroke quantization of the PLM 105. Some PLM architectures (e.g., those based on MEMS technology) provide a relatively low number of phase strokes. For an n-bit PLM device, the number of codewords is 2ⁿ. Additionally, the phase stroke quantization, which converts phase values into codewords for the PLM phase configuration, may be non-uniform. FIG. 21 illustrates this non-uniform phase stroke quantization in an exemplary 3-bit PLM device.

FIG. 21 shows the phase input along the x-axis and the phase output along the y-axis. Line 2101 corresponds to linear encoding and line 2102 corresponds to the values of the modulator look-up table. Points where lines 2101 and 2102 cross correspond to the codewords. As can be seen from FIG. 21, the 3-bit PLM device has eight codewords. The maximum stroke of the modulator corresponds to the largest codeword (i.e., the codeword corresponding to the largest phase input value). For implementations in which the algorithm that generates phase configurations for the PLM 105 are not aware of phase stroke quantization, the phase configurations when reconstructed by the PLM 105 may produce lightfield images that contain artifacts such as a substantial energy deficit in image features.

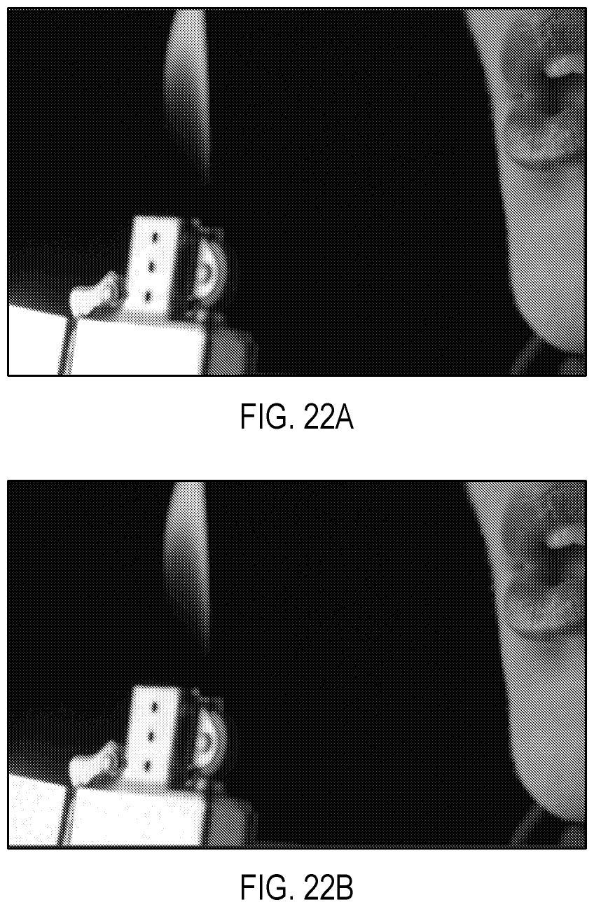

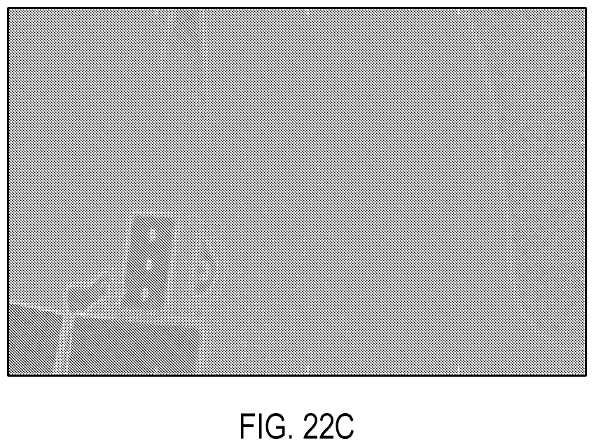

FIGS. 22A-22C respectively illustrate image frames for a video still and show these effects. FIG. 22A illustrates a target image frame, which includes bright areas (a face and a lighter in the illustrated image) on a dark background. FIG. 22B illustrates an exemplary output image in a dual-modulation projection system in which the PLM stroke quantization is simulated in the lightfield, but the algorithm that generates the phase configurations to drive the PLM is not aware of the stroke quantization process. FIG. 22C is a difference map showing the differences between FIG. 22A and FIG. 22B. In the difference map of FIG. 22C, darker areas (e.g., in the lower-left portion) indicate missing energy and lighter areas (e.g., at some object edges) indicate excess energy. As noted above, excess energy may be compensated by the primary modulator in the projection system but missing energy may not.

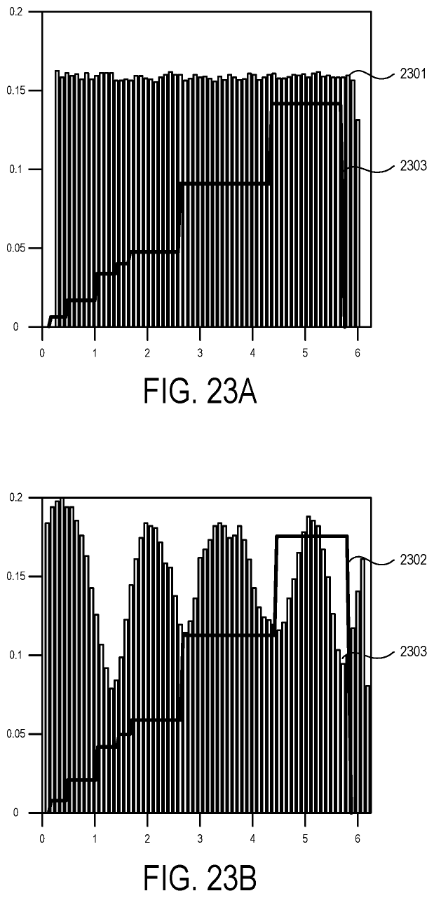

The wave-propagation loop may account for the PLM phase stroke quantization by subjecting the phase-component of the modulation field to such quantization process. In various implementations, the phase quantization of the modulation field may be performed in some or all of the iterations of the wave-propagation loop. FIGS. 23A-23B illustrate the phase distribution of a modulation field output (line 2301 in FIG. 23A, and line 2302 in FIG. 23B) at the penultimate iteration (N−1, where N is the total number of iterations). In FIG. 23A, the modulation field is not subject to the quantization process in any iteration, whereas in FIG. 23B, the quantization process is performed on all previous iterations. Line 2303 indicates the PLM quantization steps, and is overlaid on both FIGS. 23A and 23B for reference.

As can be seen from FIG. 23B, by performing the PLM phase quantization on the modulation field within the wave-propagation loop, the resultant phase configurations lead to a phase distribution that more accurately accommodates the phase codeword specifications of the particular PLM. Depending on the particular application, this may result in a higher phase construction efficiency and/or reconstructions which do not exhibit the same artifacts as phase-configurations generated from algorithms which are not aware of the quantization process (e.g., the energy deficit seen in FIG. 22C). This may be implemented using the iterative regularization techniques described above, in either an open-loop or outer-feedback (OLFB) subframe integration configuration.

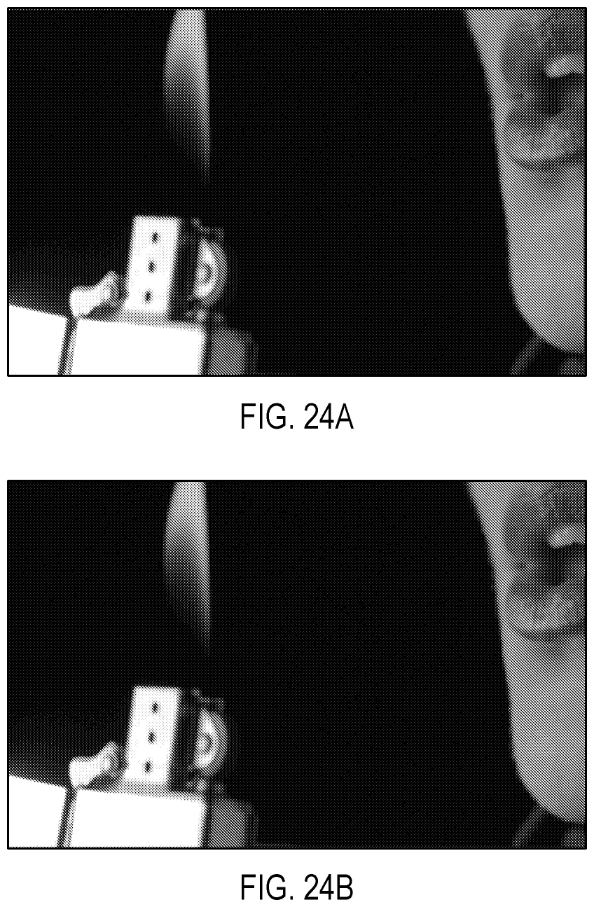

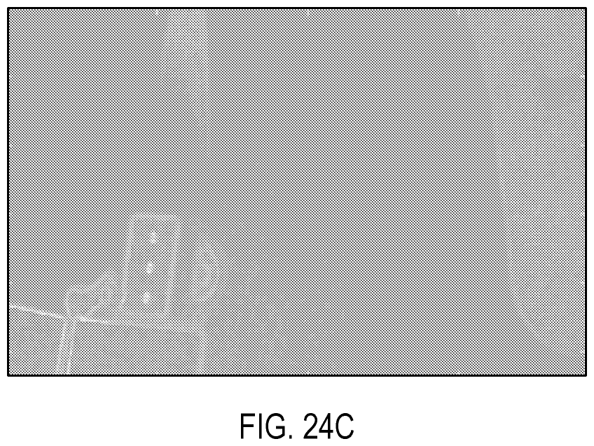

FIGS. 24A-24C respectively illustrate image frames for a video still and show the results of algorithms which are aware of the quantization process. FIG. 24A illustrates a target image frame, which includes bright areas (a face and a lighter in the illustrated image) on a dark background; this image corresponds to the target image of FIG. 22A. FIG. 24B illustrates an exemplary output image in a dual-modulation projection system in which the PLM stroke quantization is simulated in the lightfield and the algorithm that generates the phase configurations to drive the PLM is aware of the stroke quantization process. FIG. 24C is a difference map showing the differences between FIG. 24A and FIG. 24B. In the difference map of FIG. 24C, lighter areas (e.g., at some object edges) indicate excess energy. As noted above, excess energy may be compensated by the primary modulator in the projection system. By comparing FIG. 24C with FIG. 22C, it can be seen that there is no longer a substantial energy deficit in image features. The portions which show excess energy due to, for example, the system PSF may be compensated by the primary modulator, thus leading to substantially noiseless screen images.

### Effects

Systems, methods, and devices in accordance with the present disclosure may take any one or more of the following configurations.

(1) A projection system comprising a light source configured to emit a light in response to an image data; a phase light modulator configured to receive the light from the light source and to apply a spatially-varying phase modulation on the light, thereby to steer the light and generate a projection light; and a controller configured to control the light source, control the phase modulator, and iteratively for each of a plurality of subframes within a frame of the image data: determine a reconstruction field, map the reconstruction field to a modulation field, scale an amplitude of the modulation field, map the modulation field to a subsequent-iteration reconstruction field, and provide a phase control signal based on the modulation field to the phase light modulator.

(2) The projection system according to (1), wherein the modulation field is a plane of the phase light modulator which modulates a phase of the light, and wherein the reconstruction field is a plane on which a reconstruction image is formed.

(3) The projection system according to any one of (1) to (2), wherein the controller is configured to, iteratively for each of the plurality of subframes within the frame of the image data, apply a regularization factor to the reconstruction field, and wherein the regularization factor adjusts a target amplitude of the subsequent-iteration reconstruction field using a gain based on a reconstruction error of a current iteration.

(4) The projection system according to any one of (1) to (3), wherein scaling the amplitude of the modulation field includes setting an amplitude component of the modulation field to 1.

(5) The projection system according to any one of (1) to (4), wherein the controller is configured to pad the reconstruction field with a dump region before mapping the reconstruction field to the modulation field.

(6) The projection system according to any one of (1) to (5), wherein the controller is configured to, iteratively for each of a plurality of iterations within a subframe except a first iteration, generate an error signal by comparing an integrated lightfield simulation of a current iteration to a target image.

(7) The projection system according to any one of (1) to (6), further comprising a secondary modulator configured to receive and modulate the projection light, wherein the phase light modulator includes a plurality of pixel elements arranged in an array, and circuitry configured to modify respective states of the plurality of pixel elements in response to the phase control signal.

(8) A method of driving a projection system comprising emitting a light by a light source, in response to an image data; receiving the light by a phase light modulator; applying a spatially-varying phase modulation on the light by the phase light modulator, thereby to steer the light and generate a projection light; and iteratively, with a controller configured to control the light source and the phase light modulator, for each of a plurality of subframes within a frame of the image data: determining a reconstruction field, mapping the reconstruction field to a modulation field, scaling an amplitude of the modulation field, mapping the modulation field to a subsequent-iteration reconstruction field, and providing a phase control signal based on the modulation field to the phase light modulator.

(9) The method according to (8), wherein the modulation field is a plane of the phase light modulator which modulates a phase of the light, and wherein the reconstruction field is a plane on which a reconstruction image is formed.

(10) The method according to any one of (8) to (9), further comprising, iteratively for each of the plurality of subframes within the frame of the image data, applying a regularization factor to the reconstruction field, wherein the regularization factor adjusts a target amplitude of the subsequent-iteration reconstruction field using a gain based on a reconstruction error of a current iteration.

(11) The method according to any one of (8) to (10), wherein scaling the amplitude of the modulation field includes setting an amplitude component of the modulation field to 1.

(12) The method according to any one of (8) to (11), further comprising padding the reconstruction field with a dump region before mapping the reconstruction field to the modulation field.

(13) The method according to any one of (8) to (12), further comprising, iteratively for each of a plurality of iterations within a subframe except a first iteration, generating an error signal by comparing an integrated lightfield simulation of a current iteration to a target image.

(14) The method according to any one of (8) to (13), further comprising receiving and modulating the projection light by a secondary modulator, wherein the phase light modulator includes a plurality of pixel elements arranged in an array, and circuitry configured to modify respective states of the plurality of pixel elements in response to the phase control signal.

(15) A non-transitory computer-readable medium storing instructions that, when executed by a processor of a projection device, cause the projection device to perform operations comprising the method according to any one of (8) to (14).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Various aspects of the present invention may be appreciated from the following enumerated example embodiments (EEEs):
EEE1. A projection system, comprising:
   a light source configured to emit a light in response to an image data;
   a phase light modulator configured to receive the light from the light source and to apply a spatially-varying phase modulation on the light, thereby to steer the light and generate a projection light; and
   a controller configured to control the light source, control the phase light modulator, and iteratively for each of a plurality of subframes within a frame of the image data:
      determine a reconstruction field,
      map the reconstruction field to a modulation field,
      scale an amplitude of the modulation field,
      map the modulation field to a subsequent-iteration reconstruction field, and
      provide a phase control signal based on the modulation field to the phase light modulator.
EEE2. The projection system according to EEE 1, wherein the controller is configured to, iteratively for each of the plurality of subframes within the frame of the image data, apply a regularization factor to the reconstruction field.
EEE3. The projection system according to EEE 2, wherein the regularization factor adjusts a target amplitude of the subsequent-iteration reconstruction field using a gain based on a reconstruction error of a current iteration.
EEE4. The projection system according to EEE 3, wherein the gain includes a blurring filter.
EEE5. The projection system according to any one of EEEs 1 to 4, wherein the controller is configured to pad the reconstruction field with a dump region before mapping the reconstruction field to the modulation field.
EEE6. The projection system according to EEE 5, wherein the controller is configured to set virtual pixel values in the dump region to a predetermined value.
EEE7. The projection system according to any one of EEEs 1 to 6, wherein the controller is configured to, iteratively for each of a plurality of iterations within a subframe except a first iteration, generate an error signal by comparing an integrated lightfield simulation of a current iteration to a target image.
EEE8. The projection system according to EEE 7, wherein the controller is configured to, iteratively for each of the plurality of iterations except the first iteration, generate an updated target intensity based on a current target intensity and the error signal.
EEE9. The projection system according to any one of EEEs 1 to 8, further comprising a secondary modulator configured to receive and modulate the projection light.
EEE10. The projection system according to EEE 9, wherein the phase light modulator includes a plurality of pixel elements arranged in an array, and circuitry configured to modify respective states of the plurality of pixel elements in response to the phase control signal.
EEE11. A method of driving a projection system, comprising:
   emitting a light by a light source, in response to an image data;
   receiving the light by a phase light modulator;
   applying a spatially-varying phase modulation on the light by the phase light modulator, thereby to steer the light and generate a projection light; and
   iteratively, with a controller configured to control the light source and the phase light modulator, for each of a plurality of subframes within a frame of the image data:
      determining a reconstruction field,
      mapping the reconstruction field to a modulation field,
      scaling an amplitude of the modulation field,
      mapping the modulation field to a subsequent-iteration reconstruction field, and
   providing a phase control signal based on the modulation field to the phase light modulator.
EEE12. The method according to EEE 11, further comprising, iteratively for each of the plurality of subframes within the frame of the image data, applying a regularization factor to the reconstruction field.
EEE13. The method according to EEE 12, wherein the regularization factor adjusts a target amplitude of the subsequent-iteration reconstruction field using a gain based on a reconstruction error of a current iteration.
EEE14. The method according to EEE 13, wherein the gain includes a blurring filter.
EEE15. The method according to any one of EEEs 11 to 14, further comprising padding the reconstruction field with a dump region before mapping the reconstruction field to the modulation field.
EEE16. The method according to EEE 15, further comprising setting virtual pixel values in the dump region to a predetermined value.
EEE17. The method according to any one of EEEs 11 to 16, further comprising, iteratively for each of a plurality of iterations within a subframe except a first iteration, generating an error signal by comparing an integrated lightfield simulation of a current iteration to a target image.
EEE18. The method according to EEE 17, further comprising, iteratively for each of the plurality of iterations except the first iteration, generating an updated target intensity based on a current target intensity and the error signal.
EEE19. The method according to EEE 11, further comprising receiving and modulating the projection light by a secondary modulator.
EEE20. A non-transitory computer-readable medium storing instructions that, when executed by a processor of a projection device, cause the projection device to perform operations comprising the method according to any one of EEEs 11 to 19.

1. A projection system, comprising:
a light source configured to emit a light in response to an image data;
a phase light modulator configured to receive the light from the light source and to apply a spatially-varying phase modulation on the light, thereby generating a projection light and steering the light on a reconstruction field, wherein the reconstruction field is a complex plane on which a reconstruction image is formed; and
a controller configured to
control the light source,
control the phase light modulator,
initialize the reconstruction field to an initial value, and
iteratively for each of a plurality of subframes within a frame of the image data:
set the reconstruction field to the initial value for the first iteration or set the reconstruction field to a subsequent-iteration reconstruction field value for any subsequent-iteration,
map the reconstruction field to a modulation field, wherein the modulation field is a complex plane of the phase light modulator which modulates a phase of the light,
set an amplitude of the modulation field to a predetermined value, and
map the modulation field with the amplitude set to the predetermined value, to a subsequent-iteration reconstruction field;
wherein the controller is further configured to provide a phase control signal based on the modulation field mapped with the last iteration to the phase light modulator.

2. The projection system according to claim 1, wherein the controller is configured to iteratively: set the reconstruction field to an initial value, map the reconstruction field to the modulation field, set the amplitude of the modulation field to a predetermined value, and map the modulation field having the amplitude set to the predetermined value to a subsequent-iteration reconstruction field, until the subsequent-iteration reconstruction field reaches a target image quality.

3. The projection system according to claim 1, wherein the controller is configured to, iteratively for each of the plurality of subframes within the frame of the image data, apply a regularization factor to the subsequent-iteration reconstruction field.

4. The projection system according to claim 3, wherein the regularization factor adjusts a target amplitude of the subsequent-iteration reconstruction field using a gain function based on a reconstruction error of a current iteration.

5. The projection system of claim 4, wherein the gain includes a blurring filter.

6. The projection system according to claim 1, wherein the controller is configured to set an amplitude component of the modulation field to 1.

7. The projection system according to claim 1, wherein the controller is configured to pad the reconstruction field with a dump region before mapping the reconstruction field to the modulation field.

8. The projection system according to claim 7, wherein the controller is configured to set virtual pixel values in the dump region to a predetermined value.

9. The projection system according to claim 1, wherein the controller is configured to, iteratively for each of a plurality of iterations within a subframe except a first iteration, generate an error signal by comparing an integrated lightfield simulation of a current iteration to a target image.

10. The projection system according to claim 9, wherein the controller is configured to, iteratively for each of the plurality of iterations except the first iteration, generate an updated target intensity based on a current target intensity and the error signal.

11. The projection system according to claim 1, further comprising a secondary modulator configured to receive and modulate the projection light.

12. The projection system of claim 11, wherein the phase light modulator includes a plurality of pixel elements arranged in an array, and circuitry configured to modify respective states of the plurality of pixel elements in response to the phase control signal.

13. A method of driving a projection system, comprising:
emitting a light by a light source, in response to an image data;
receiving the light by a phase light modulator;
applying a spatially-varying phase modulation on the light by the phase light modulator, thereby generating a projection light and steering the light on a reconstruction field, wherein the reconstruction field is a complex plane on which a reconstruction image is formed;
initializing the reconstruction field to an initial value; and
iteratively, with a controller configured to control the light source and the phase light modulator, for each of a plurality of subframes within a frame of the image data:
setting the reconstruction field to the initial value for the first iteration or setting the reconstruction field to a subsequent-iteration reconstruction field value for any subsequent-iteration,
mapping the reconstruction field to a modulation field, wherein the modulation field is a complex plane of the phase light modulator which modulates a phase of the light,
setting an amplitude of the modulation field to a predetermined value,
mapping the modulation field with the amplitude set to the predetermined value, to a subsequent-iteration reconstruction field; and
providing a phase control signal based on the modulation field mapped with the last iteration to the phase light modulator.

14. The method according to claim 13, wherein setting the reconstruction field to an initial value, mapping the reconstruction field to the modulation field, setting the amplitude of the modulation field to a predetermined value, and mapping the modulation field having the amplitude set to the predetermined value to a subsequent-iteration reconstruction field, are iteratively performed until the subsequent-iteration reconstruction field reaches a target image quality.

15. The method according to claim 13, further comprising, iteratively for each of the plurality of subframes within the frame of the image data, applying a regularization factor to the reconstruction field.

16. The method of claim 15, wherein the regularization factor adjusts a target amplitude of the subsequent-iteration reconstruction field using a gain based on a reconstruction error of a current iteration.

17. The method of claim 16, wherein the gain includes a blurring filter.

18. The method according to claim 13, wherein scaling the amplitude of the modulation field includes setting an amplitude component of the modulation field to 1.

19. The method according to claim 13, further comprising padding the reconstruction field with a dump region before mapping the reconstruction field to the modulation field.

20. The method of claim 19, further comprising setting virtual pixel values in the dump region to a predetermined value.

21. The method according to claim 13, further comprising, iteratively for each of a plurality of iterations within a subframe except a first iteration, generating an error signal by comparing an integrated lightfield simulation of a current iteration to a target image.

22. The method according to claim 21, further comprising, iteratively for each of the plurality of iterations except the first iteration, generating an updated target intensity based on a current target intensity and the error signal.

23. The method according to claim 13, further comprising receiving and modulating the projection light by a secondary modulator.

24. The method according to claim 23, wherein the phase light modulator includes a plurality of pixel elements arranged in an array, and circuitry configured to modify respective states of the plurality of pixel elements in response to the phase control signal.

25. A non-transitory computer-readable medium storing instructions that, when executed by a processor of a projection device, cause the projection device to perform operations comprising the method according to claim 13.
